(19) United States
(12) Patent Application Publication
(10) Pub. No.: US 2025/0159530 A1
(43) Pub. Date: May 15, 2025

(54) CROSS LINK INTERFERENCE MEASUREMENT RESOURCE INDICATION

(71) Applicant: QUALCOMM Incorporated, San Diego, CA (US)

(72) Inventors: Yuwei REN, Beijing (CN); Yan ZHOU, San Diego, CA (US); Huilin XU, Temecula, CA (US); Qian ZHANG, Basking Ridge, NJ (US)

(21) Appl. No.: 18/839,938

(22) PCT Filed: Apr. 30, 2022
(86) PCT No.: PCT/CN2022/090823

§ 371 Date: Aug. 20, 2024

(51) Int. Cl. H04W 24/10; H04L 5/00

(52) U.S. Cl. CPC H04W 24/10; H04L 5/0053

(57) ABSTRACT

This disclosure provides systems, methods, and apparatuses for enabling a cross link interference (CLI) measurement resource indication. In some aspects, a first user equipment (UE) may receive configuration information indicating multiple CLI measurement resources that are associated with measuring CLI from a second UE. A network entity may configure a CLI measurement resource set, including the multiple CLI measurement resources, for the first UE to measure CLI associated with the second UE. The first UE may receive a communication indicating a CLI measurement resource, from the multiple CLI measurement resources, to be used to measure the CLI from the second UE. The indication of the CLI measurement resource to be used by the first UE may enable the CLI measurement resource used by the first UE to be dynamically changed to ensure that the CLI measurement resource aligns with an active bandwidth part (BWP) of the second UE.

### TECHNICAL FIELD

Aspects of the present disclosure relate generally to wireless communication and to techniques for a cross link interference (CLI) measurement resource indication.

### DESCRIPTION OF THE RELATED TECHNOLOGY

Wireless communication systems are widely deployed to provide various telecommunication services such as telephony, video, data, messaging, and broadcasts. Typical wireless communication systems may employ multiple-access technologies capable of supporting communication with multiple users by sharing available system resources (for example, bandwidth, transmit power, etc.). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network entities that support communication for wireless communication devices, such as a user equipment (UE) or multiple UEs. A UE may communicate with a network entity via downlink communications and uplink communications. “Downlink” (or “DL”) refers to a communication link from the network entity to the UE, and “uplink” (or “UL”) refers to a communication link from the UE to the network entity.

These multiple access technologies have been adopted in various telecommunication standards to provide a common protocol that enables different UEs to communicate on a municipal, national, regional, or global level. New Radio (NR), which also may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency-division multiplexing (OFDM) with a cyclic prefix (CP) (CP-OFDM) on the downlink, using CP-OFDM or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation.

### SUMMARY

The systems, methods, and devices of this disclosure each have several innovative aspects, no single one of which is solely responsible for the desirable attributes disclosed herein.

One innovative aspect of the subject matter described in this disclosure can be implemented in a method of wireless communication performed by an apparatus of a user equipment (UE). The method may include receiving, from a network entity, configuration information indicating multiple cross link interference (CLI) measurement resources that are associated with measuring CLI from a second UE. The method may include receiving, from the network entity, a communication indicating a CLI measurement resource, from the multiple CLI measurement resources, to be used to measure the CLI from the second UE. The method may include transmitting, to the network entity, a CLI report indicating one or more measurements that are associated with the CLI measurement resource.

In some implementations, the method can include receiving, from the network entity, another communication indicating another CLI measurement resource, from the multiple CLI measurement resources, to be used to measure the CLI from the second UE. The method can include transmitting, to the network entity, another CLI report indicating one or more measurements that are associated with the other CLI measurement resource.

In some implementations, the method can include receiving, from the second UE, one or more signals that are associated with the CLI measurement resource. The method can include measuring the one or more signals to obtain the one or more measurements. In some implementations, the configuration information indicates that each of the multiple CLI measurement resources is associated with a same resource set. In some implementations, the configuration information indicates that a first one or more CLI measurement resources, from the multiple CLI measurement resources, are associated with a first subset of the same resource set, and that a second one or more CLI measurement resources, from the multiple CLI measurement resources, are associated with a second subset of the same resource set.

Another innovative aspect of the subject matter described in this disclosure can be implemented in an apparatus of a first UE for wireless communication. The apparatus may include one or more interfaces configured to obtain, from a network entity, configuration information indicating multiple CLI measurement resources that are associated with measuring CLI from a second UE. The one or more interfaces may be configured to obtain, from the network entity, a communication indicating a CLI measurement resource, from the multiple CLI measurement resources, to be used to measure the CLI from the second UE. The one or more interfaces may be configured to output, to the network entity, a CLI report indicating one or more measurements that are associated with the CLI measurement resource.

Another innovative aspect of the subject matter described in this disclosure can be implemented in a non-transitory computer-readable medium. The non-transitory computer-readable medium may store one or more instructions for wireless communication. The one or more instructions, when executed by one or more processors of a first UE, may cause the one or more processors to receive, from a network entity, configuration information indicating multiple CLI measurement resources that are associated with measuring CLI from a second UE. The one or more instructions, when executed by one or more processors of the first UE, may cause the one or more processors to receive, from the network entity, a communication indicating a CLI measurement resource, from the multiple CLI measurement resources, to be used to measure the CLI from the second UE. The one or more instructions, when executed by one or more processors of the first UE, may cause the one or more processors to transmit, to the network entity, a CLI report indicating one or more measurements that are associated with the CLI measurement resource.

Another innovative aspect of the subject matter described in this disclosure can be implemented in a first apparatus for wireless communication. The first apparatus may include means for receiving, from a network entity, configuration information indicating multiple CLI measurement resources that are associated with measuring CLI from a second apparatus. The first apparatus may include means for receiving, from the network entity, a communication indicating a CLI measurement resource, from the multiple CLI measurement resources, to be used to measure the CLI from the second apparatus. The first apparatus may include means for transmitting, to the network entity, a CLI report indicating one or more measurements that are associated with the CLI measurement resource.

Another innovative aspect of the subject matter described in this disclosure can be implemented in a method of wireless communication performed by an apparatus of a network entity. The method may include transmitting configuration information intended for a first UE indicating multiple CLI measurement resources that are associated with measuring CLI from a second UE. The method may include transmitting a communication indicating a CLI measurement resource, from the multiple CLI measurement resources, to be used to measure the CLI from the second UE. The method may include receiving a CLI report indicating one or more measurements that are associated with the CLI measurement resource.

In some implementations, the method can include transmitting another communication indicating another CLI measurement resource, from the multiple CLI measurement resources, to be used to measure the CLI from the second UE. The method can include receiving another CLI report indicating one or more measurements that are associated with the other CLI measurement resource.

In some implementations, the method can include detecting that the second UE has switched from a second bandwidth part to the first bandwidth part. The method can include transmitting the communication to cause the first UE to use the CLI measurement resource, that corresponds to the first uplink bandwidth part, to measure the CLI from the second UE.

Another innovative aspect of the subject matter described in this disclosure can be implemented in an apparatus of a base station for wireless communication. The apparatus may include one or more interfaces configured to output configuration information intended for a first UE indicating multiple CLI measurement resources that are associated with measuring CLI from a second UE. The one or more interfaces may be configured to output a communication indicating a CLI measurement resource, from the multiple CLI measurement resources, to be used to measure the CLI from the second UE. The one or more interfaces may be configured to obtain a CLI report indicating one or more measurements that are associated with the CLI measurement resource.

Another innovative aspect of the subject matter described in this disclosure can be implemented in a non-transitory computer-readable medium. The non-transitory computer-readable medium may store one or more instructions for wireless communication. The one or more instructions, when executed by one or more processors of a network entity, may cause the one or more processors to transmit configuration information intended for a first UE indicating multiple CLI measurement resources that are associated with measuring CLI from a second UE. The one or more instructions, when executed by one or more processors of the network entity, may cause the one or more processors to transmit a communication indicating a CLI measurement resource, from the multiple CLI measurement resources, to be used to measure the CLI from the second UE. The one or more instructions, when executed by one or more processors of the network entity, may cause the one or more processors to receive a CLI report indicating one or more measurements that are associated with the CLI measurement resource.

Another innovative aspect of the subject matter described in this disclosure can be implemented in an apparatus for wireless communication. The apparatus may include means for transmitting configuration information intended for a first UE indicating multiple CLI measurement resources that are associated with measuring CLI from a second UE. The apparatus may include means for transmitting a communication indicating a CLI measurement resource, from the multiple CLI measurement resources, to be used to measure the CLI from the second UE. The apparatus may include means for receiving a CLI report indicating one or more measurements that are associated with the CLI measurement resource.

Aspects generally include a method, apparatus, system, computer program product, non-transitory computer-readable medium, user equipment, base station, network entity, network node, wireless communication device, or processing system as substantially described herein with reference to and as illustrated by the accompanying drawings.

Details of one or more implementations of the subject matter described in this disclosure are set forth in the accompanying drawings and the description. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 is a diagram illustrating an example of a wireless network.

FIG. 2 is a diagram illustrating an example of a base station in communication with a user equipment (UE) in a wireless network.

FIG. 3 is a diagram illustrating an example disaggregated base station architecture.

FIG. 4A is a diagram illustrating an example relating to cross link interference (CLI) detection and mitigation.

FIG. 4B is a diagram illustrating example time division duplexing (TDD) patterns potentially introducing CLI.

FIG. 5 is a diagram illustrating an example relating to bandwidth part (BWP) switching associated with CLI measurements.

FIG. 6 is a diagram of an example associated with a CLI measurement resource indication.

FIG. 7 is a diagram of an example associated with a CLI measurement resource indication.

FIG. 8 is a diagram illustrating an example process performed, for example, by a UE.

FIG. 9 is a diagram illustrating an example process performed, for example, by a network entity.

FIG. 10 is a diagram of an example apparatus for wireless communication.

FIG. 11 is a diagram of an example apparatus for wireless communication.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. Some of the examples in this disclosure are based on wireless and wired local area network (LAN) communication according to the Institute of Electrical and Electronics Engineers (IEEE) 802.11 wireless standards, the IEEE 802.3 Ethernet standards, and the IEEE 1901 Powerline communication (PLC) standards. However, the described implementations may be implemented in any device, system or network that is capable of transmitting and receiving radio frequency signals according to any of the wireless communication standards, including any of the IEEE 802.11 standards, the Bluetooth© standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless, cellular or internet of things (IOT) network, such as a system utilizing 3G technology, 4G technology, 5G technology, or further implementations thereof.

When neighboring network entities use different time division duplexing (TDD) configurations to communicate with different user equipment (UEs), downlink communication between a first network entity and a first UE may occur in a same transmission time interval (TTI) as an uplink communication between a second network entity and a second UE. These communications in different transmission directions (for example, downlink vs. uplink) in the same TTI may interfere with one another, which may be referred to as cross link interference (CLI).

In some cases, the first UE may provide a CLI measurement report to a network entity (such as the first network entity) that indicates CLI measurement information caused by uplink communications transmitted by the second UE. For example, a victim UE (for example, the first UE that is experiencing CLI) may be configured with a CLI measurement resource (such as one or more air interface resources or one or more time-frequency resources) to measure CLI caused by an aggressor UE (for example, the second UE that is transmitting uplink communications that is causing CLI). The network entity may use the CLI measurement report to determine modified air interface resource assignments (for example, modified gap frequency band sizes, modified frequency assignments, modified time assignments, or modified modulation and coding scheme (MCS) assignments, among other examples) for downlink transmissions or uplink transmissions by the first UE to mitigate the CLI experienced by the first UE. In other words, based on or associated with the CLI measurement report, the network entity may select modified air interface resources to reduce CLI observed by the first UE, reduce recovery errors at the first UE, or increase data throughput at the first UE, among other examples.

However, in some cases, an aggressor UE (for example, the second UE that is transmitting uplink communications that is causing CLI) may switch or change frequency domain resources used to transmit uplink communications over time. For example, a bandwidth part (BWP) used by the aggressor UE to transmit uplink communications may change over time. In some cases, frequency domain resources associated with the CLI measurement resource that is configured for the victim UE to measure the CLI caused by the aggressor UE may not align with a BWP that is used by the aggressor UE when the aggressor UE switches BWPs. Because the frequency domain resources associated with the CLI measurement resource may not align (for example, at least partially overlap with) the frequency domain resources of the active BWP of the aggressor UE, the CLI measurements performed by the victim UE using the CLI measurement resource may not provide meaningful information associated with CLI caused by uplink transmissions from the aggressor UE (for example, because the uplink transmission may use different frequency domain resources than the frequency domain resources that are measured by the victim UE).

In other words, a configured CLI measurement resource (for example, the CLI measurement resource) may not always map to (for example, align with) the active BWP of the aggressor UE. As a result, a reported CLI measurement (for example, that is obtained by measuring the CLI measurement resource that does not align with the aggressor UE's active BWP) may reflect inaccurate CLI information associated with the aggressor UE, resulting in a network entity making degraded or incorrect determinations associated with a configuration or resource allocation for the victim UE.

Further, configuring new or additional CLI measurement resources each time an aggressor UE switches an active BWP may consume significant signaling overhead. Additionally, configuring multiple CLI measurement resources for a victim UE associated with the same aggressor UE may consume processing and network resources. Moreover, this may consume an available CLI measurement resource budget (for example, defined, or otherwise fixed, by a wireless communication standard or a capability of the victim UE). If the victim UE is configured with multiple CLI measurement resources for the same aggressor UE, a resource availability associated with the victim UE measuring CLI associated with other aggressor UEs may be reduced. Therefore, the victim UE may measure CLI using CLI measurement resources that do not align in the frequency domain with an active BWP of the aggressor UE. Additionally, or alternatively, a network entity or the victim UE may consume significant signaling overhead, processing resources, network resources, or power resources, among other examples, associated with configuring, measuring, or reporting on, among other examples, multiple CLI measurement resources for the same aggressor UE.

Some implementations described herein enable a CLI measurement resource indication. For example, a first UE (such as a victim UE) may receive configuration information indicating multiple CLI measurement resources that are associated with measuring CLI from a second UE (such as an aggressor UE). For example, a network entity may configure a CLI measurement resource set, including the multiple CLI measurement resources, for the first UE to measure CLI caused by uplink transmissions from the second UE. The multiple CLI measurement resources may include CLI measurement resources that are associated with frequency domain resources that at least partially overlap with frequency domain resources associated with different BWPs configured for the second UE (for example, a first CLI measurement resource associated with frequency domain resources that at least partially overlap with frequency domain resources associated with a first BWP, and a second CLI measurement resource associated with frequency domain resources that at least partially overlap with frequency domain resources associated with a second BWP, among other examples).

The first UE may receive a communication indicating a CLI measurement resource, from the multiple CLI measurement resources, to be used to measure the CLI from the second UE. For example, the communication may be, or may be included in, a medium access control (MAC) control element (MAC-CE) communication, a downlink control channel communication, or a downlink control information (DCI) communication, among other examples. For example, the CLI measurement resource may align with (at least partially overlap in the frequency domain with) an active BWP of the second UE. If the second UE switches the active BWP to a second BWP, then the first UE may receive a second communication indicating a second CLI measurement resource, from the multiple CLI measurement resources, to be used to measure the CLI from the second UE (for example, where the second CLI measurement resource aligns with or corresponds to the second BWP). Therefore, the indication of the CLI measurement resource to be used by the first UE may enable the CLI measurement resource used by the first UE to be dynamically changed to ensure that the CLI measurement resource aligns with an active BWP of the second UE (for example, the aggressor UE). The first UE may transmit a CLI report (a CLI measurement report) indicating one or more measurements that are associated with the CLI measurement resource that is activated at a given time. For example, the first UE may measure one or more uplink signals transmitted by the second UE via the CLI measurement resource to obtain the one or more measurements.

Particular implementations of the subject matter described in this disclosure can be implemented to realize one or more of the following potential advantages. For example, the indication of the CLI measurement resource to be used by first UE may ensure that the CLI measurement resource at least partially overlaps in the frequency domain with an active BWP of the second UE. By enabling the first UE to switch CLI measurement resources to align with the active BWP of the second UE, the reported CLI measurements may provide more insightful or more accurate CLI information associated with the second UE. As a result, the determinations made by a network entity based on or associated with the reported CLI information may be improved. This may improve a communication performance, efficiency, or throughput, among other examples, of the first UE or a network in which the first UE is communicating. As another example, the indication of the CLI measurement resource may be associated with reduced latency and efficient resource utilization (for example, as compared to radio resource control (RRC) signaling). Further, by enabling the first UE to switch CLI measurement resources to align with the active BWP of the second UE, the CLI measurements performed by the first UE may be more accurate (for example, than if the first UE were to measure a CLI measurement resource that did not align with the active BWP of the second UE). As a result, the network (for example, one or more network entities) may be enabled to make improved CLI estimations and thereby improve a throughput experienced by the first UE.

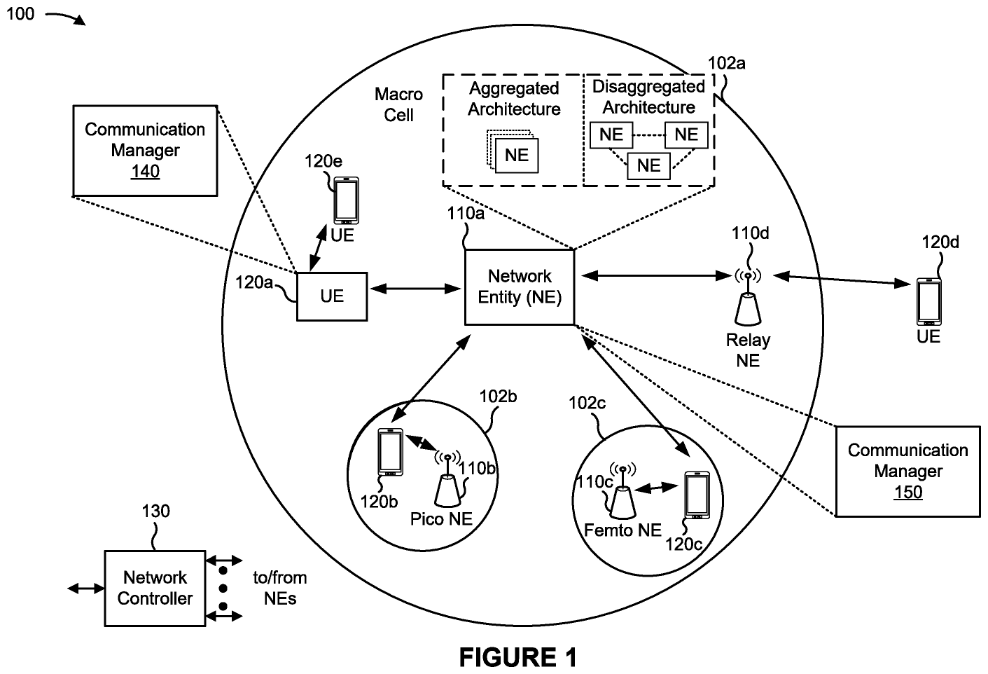

FIG. 1 is a diagram illustrating an example of a wireless network 100. The wireless network 100 may be or may include elements of a 5G (for example, NR) network or a 4G (for example, Long Term Evolution (LTE)) network, among other examples. The wireless network 100 may include one or more network entities, such as one or more network entities 110 (shown as a network entity 110a, a network entity 110b, a network entity 110c, and a network entity 110d), a user equipment (UE) 120 or multiple UEs 120 (shown as a UE 120a, a UE 120b, a UE 120c, a UE 120d, and a UE 120e), or other entities. A network entity 110 is an example of a network entity that communicates with UEs 120. As shown, a network entity 110 may include one or more network entities. For example, a network entity 110 may be an aggregated network entity, meaning that the aggregated network node is configured to utilize a radio protocol stack that is physically or logically integrated within a single RAN node (for example, within a single device or unit). As another example, a network entity 110 may be a disaggregated network node (sometimes referred to as a disaggregated base station), meaning that the network entity 110 includes two or more non-co-located network nodes. A disaggregated network entity may be configured to utilize a protocol stack that is physically or logically distributed among two or more nodes (such as one or more central units (CUs), one or more distributed units (DUs), or one or more radio units (RUs)).

In some examples, a network entity 110 includes an entity that communicates with UEs 120 via a radio access link, such as an RU. In some examples, a network entity 110 includes an entity that communicates with other network entities 110 via a fronthaul link or a midhaul link, such as a DU. In some examples, a network entity 110 includes an entity that communicates with other network entities 110 via a midhaul link or a core network via a backhaul link, such as a CU. In some examples, a network entity 110 (such as an aggregated network entity 110 or a disaggregated network entity 110) may include multiple network entities, such as one or more RUs, one or more CUs, or one or more DUs. A network entity 110 may include, for example, an NR base station, an LTE base station, a Node B, an eNB (for example, in 4G), a gNB (for example, in 5G), an access point, or a transmission reception point (TRP), a DU, an RU, a CU, a mobility element of a network, a core network node, a network element, a network equipment, a RAN node, or a combination thereof. In some examples, the network entities 110 may be interconnected to one another or to one or more other network entities 110 in the wireless network 100 through various types of fronthaul, midhaul, or backhaul interfaces, such as a direct physical connection, an air interface, or a virtual network, using any suitable transport network.

In some examples, a network entity 110 may provide communication coverage for a particular geographic area. In the Third Generation Partnership Project (3GPP), the term “cell” can refer to a coverage area of a network entity 110 or a network entity subsystem serving this coverage area, depending on the context in which the term is used.

A network entity 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (for example, a home) and may allow restricted access by UEs 120 having association with the femto cell (for example, UEs 120 in a closed subscriber group (CSG)). A network entity 110 for a macro cell may be referred to as a macro network entity. A network entity 110 for a pico cell may be referred to as a pico network entity. A network entity 110 for a femto cell may be referred to as a femto network entity or an in-home network entity. In the example shown in FIG. 1, the network entity 110a may be a macro network entity for a macro cell 102a, the network entity 110b may be a pico network entity for a pico cell 102b, and the network entity 110c may be a femto network entity for a femto cell 102c. A network entity may support one or multiple (for example, three) cells. In some examples, a cell may not necessarily be stationary, and the geographic area of the cell may move according to the location of a network entity 110 that is mobile (for example, a mobile network entity).

In some aspects, the term “base station” or “network entity” may refer to an aggregated base station, a disaggregated base station, an integrated access and backhaul (IAB) node, a relay node, or one or more components thereof. For example, in some aspects, “base station” or “network entity” may refer to a CU, a DU, an RU, a Near-Real Time (Near-RT) RAN Intelligent Controller (RIC), or a Non-Real Time (Non-RT) RIC, or a combination thereof. In some aspects, the term “base station” or “network entity” may refer to one device configured to perform one or more functions, such as those described herein in connection with the network entity 110. In some aspects, the term “base station” or “network entity” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the term “base station” or “network entity” may refer to any one or more of those different devices. In some aspects, the term “base station” or “network entity” may refer to one or more virtual base stations or one or more virtual base station functions. For example, in some aspects, two or more base station functions may be instantiated on a single device. In some aspects, the term “base station” or “network entity” may refer to one of the base station functions and not another. In this way, a single device may include more than one base station.

The wireless network 100 may include one or more relay stations. A relay station is a network entity that can receive a transmission of data from an upstream station (for example, a network entity 110 or a UE 120) and send a transmission of the data to a downstream station (for example, a UE 120 or a network entity 110). A relay station may be a UE 120 that can relay transmissions for other UEs 120. In the example shown in FIG. 1, the network entity 110d (for example, a relay network entity) may communicate with the network entity 110a (for example, a macro network entity) and the UE 120d in order to facilitate communication between the network entity 110a and the UE 120d. A network entity 110 that relays communications may be referred to as a relay station, a relay base station, a relay network entity, a relay node, or a relay, among other examples.

The wireless network 100 may be a heterogeneous network that includes network entities 110 of different types, such as macro network entities, pico network entities, femto network entities, or relay network entities. These different types of network entities 110 may have different transmit power levels, different coverage areas, or different impacts on interference in the wireless network 100. For example, macro network entities may have a high transmit power level (for example, 5 to 40 watts) whereas pico network entities, femto network entities, and relay network entities may have lower transmit power levels (for example, 0.1 to 2 watts).

A network controller 130 may couple to or communicate with a set of network entities 110 and may provide coordination and control for these network entities 110. The network controller 130 may communicate with the network entities 110 via a backhaul communication link or a midhaul communication link. The network entities 110 may communicate with one another directly or indirectly via a wireless or wireline backhaul communication link. In some aspects, the network controller 130 may be a CU, or may include a CU or a core network device.

The UEs 120 may be dispersed throughout the wireless network 100, and each UE 120 may be stationary or mobile. A UE 120 may include, for example, an access terminal, a terminal, a mobile station, or a subscriber unit. A UE 120 may be a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, smart jewelry (for example, a smart ring or a smart bracelet)), an entertainment device (for example, a music device, a video device, or a satellite radio), a vehicular component or sensor, a smart meter/sensor, industrial manufacturing equipment, a global positioning system device, a UE function of a network entity, or any other suitable device that is configured to communicate via a wireless or wired medium.

Some UEs 120 may be considered machine-type communication (MTC) or evolved or enhanced machine-type communication (eMTC) UEs. An MTC UE or an eMTC UE may include, for example, a robot, a drone, a remote device, a sensor, a meter, a monitor, or a location tag, that may communicate with a base station, another device (for example, a remote device), or some other entity. Some UEs 120 may be considered Internet-of-Things (IoT) devices, or may be implemented as NB-IoT (narrowband IoT) devices. Some UEs 120 may be considered a Customer Premises Equipment. A UE 120 may be included inside a housing that houses components of the UE 120, such as processor components or memory components. In some examples, the processor components and the memory components may be coupled together. For example, the processor components (for example, one or more processors) and the memory components (for example, a memory) may be operatively coupled, communicatively coupled, electronically coupled, or electrically coupled.

In general, any number of wireless networks 100 may be deployed in a given geographic area. Each wireless network 100 may support a particular RAT and may operate on one or more frequencies. A RAT may be referred to as a radio technology or an air interface. A frequency may be referred to as a carrier or a frequency channel. Each frequency may support a single RAT in a given geographic area in order to avoid interference between wireless networks of different RATs. In some cases, NR or 5G RAT networks may be deployed.

In some examples, two or more UEs 120 (for example, shown as UE 120a and UE 120e) may communicate directly using one or more sidelink channels (for example, without using a network entity 110 as an intermediary to communicate with one another). For example, the UEs 120 may communicate using peer-to-peer (P2P) communications, device-to-device (D2D) communications, a vehicle-to-everything (V2X) protocol (for example, which may include a vehicle-to-vehicle (V2V) protocol, a vehicle-to-infrastructure (V2I) protocol, or a vehicle-to-pedestrian (V2P) protocol), or a mesh network. In such examples, a UE 120 may perform scheduling operations, resource selection operations, or other operations described elsewhere herein as being performed by the network entity 110.

Devices of the wireless network 100 may communicate using the electromagnetic spectrum, which may be subdivided by frequency or wavelength into various classes, bands, or channels. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz. Although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics or FR2 characteristics, and thus may effectively extend features of FR1 or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With these examples in mind, unless specifically stated otherwise, the term “sub-6 GHz,” if used herein, may broadly represent frequencies that may be less than 6 GHz, may be within FR1, or may include mid-band frequencies. Further, unless specifically stated otherwise, the term “millimeter wave,” if used herein, may broadly represent frequencies that may include mid-band frequencies, may be within FR2, FR4, FR4-a or FR4-1, or FR5, or may be within the EHF band. It is contemplated that the frequencies included in these operating bands (for example, FR1, FR2, FR3, FR4, FR4-a, FR4-1, or FR5) may be modified, and techniques described herein are applicable to those modified frequency ranges.

In some aspects, the UE 120 may include a communication manager 140. As described in more detail elsewhere herein, the communication manager 140 may receive, from a network entity, configuration information indicating multiple CLI measurement resources that are associated with measuring CLI from a second UE; receive, from the network entity, a communication indicating a CLI measurement resource, from the multiple CLI measurement resources, to be used to measure the CLI from the second UE; and transmit, to the network entity, a CLI report indicating one or more measurements that are associated with the CLI measurement resource. Additionally, or alternatively, the communication manager 140 may perform one or more other operations described herein.

In some aspects, a network entity 110 may include a communication manager 150. As described in more detail elsewhere herein, the communication manager 150 may transmit configuration information intended for a first UE indicating multiple CLI measurement resources that are associated with measuring CLI from a second UE; transmit a communication indicating a CLI measurement resource, from the multiple CLI measurement resources, to be used to measure the CLI from the second UE; and receive a CLI report indicating one or more measurements that are associated with the CLI measurement resource. Additionally, or alternatively, the communication manager 150 may perform one or more other operations described herein.

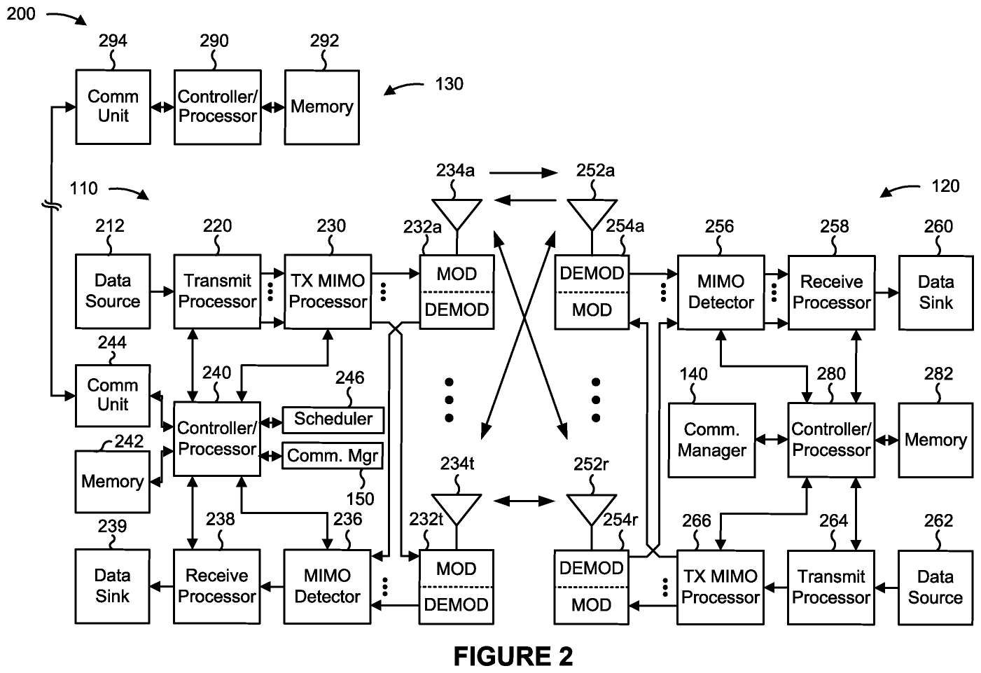

FIG. 2 is a diagram illustrating an example 200 of a network entity 110 in communication with a UE 120 in a wireless network 100. The network entity 110 may be equipped with a set of antennas 234a through 234t, such as T antennas (T≥1). The UE 120 may be equipped with a set of antennas 252a through 252r, such as R antennas (R≥1). The network entity 110 of example 200 includes one or more radio frequency components, such as antennas 234 and a modem 254. In some examples, a network entity 110 may include an interface, a communication component, or another component that facilitates communication with the UE 120 or another network entity. Some network entities 110 may not include radio frequency components that facilitate direct communication with the UE 120, such as one or more CUs, or one or more DUs.

At the network entity 110, a transmit processor 220 may receive data, from a data source 212, intended for the UE 120 (or a set of UEs 120). The transmit processor 220 may select one or more modulation and coding schemes (MCSs) for the UE 120 using one or more channel quality indicators (CQIs) received from that UE 120. The network entity 110 may process (for example, encode and modulate) the data for the UE 120 using the MCS(s) selected for the UE 120 and may provide data symbols for the UE 120. The transmit processor 220 may process system information (for example, for semi-static resource partitioning information (SRPI)) and control information (for example, CQI requests, grants, or upper layer signaling) and provide overhead symbols and control symbols. The transmit processor 220 may generate reference symbols for reference signals (for example, a cell-specific reference signal (CRS) or a demodulation reference signal (DMRS)) and synchronization signals (for example, a primary synchronization signal (PSS) or a secondary synchronization signal (SSS)). A transmit (TX) multiple-input multiple-output (MIMO) processor 230 may perform spatial processing (for example, precoding) on the data symbols, the control symbols, the overhead symbols, or the reference symbols, if applicable, and may provide a set of output symbol streams (for example, T output symbol streams) to a corresponding set of modems 232 (for example, T modems), shown as modems 232a through 232t. For example, each output symbol stream may be provided to a modulator component (shown as MOD) of a modem 232. Each modem 232 may use a respective modulator component to process a respective output symbol stream (for example, for OFDM) to obtain an output sample stream. Each modem 232 may further use a respective modulator component to process (for example, convert to analog, amplify, filter, or upconvert) the output sample stream to obtain a downlink signal. The modems 232a through 232t may transmit a set of downlink signals (for example, T downlink signals) via a corresponding set of antennas 234 (for example, T antennas), shown as antennas 234a through 234t.

At the UE 120, a set of antennas 252 (shown as antennas 252a through 252r) may receive the downlink signals from the network entity 110 or other network entities 110 and may provide a set of received signals (for example, R received signals) to a set of modems 254 (for example, R modems), shown as modems 254a through 254r. For example, each received signal may be provided to a demodulator component (shown as DEMOD) of a modem 254. Each modem 254 may use a respective demodulator component to condition (for example, filter, amplify, downconvert, or digitize) a received signal to obtain input samples. Each modem 254 may use a demodulator component to further process the input samples (for example, for OFDM) to obtain received symbols. A MIMO detector 256 may obtain received symbols from the modems 254, may perform MIMO detection on the received symbols if applicable, and may provide detected symbols. A receive processor 258 may process (for example, demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, or a CQI parameter, among other examples. In some examples, one or more components of the UE 120 may be included in a housing.

The network controller 130 may include a communication unit 294, a controller/processor 290, and a memory 292. The network controller 130 may include, for example, one or more devices in a core network. The network controller 130 may communicate with the network entity 110 via the communication unit 294.

One or more antennas (for example, antennas 234a through 234t or antennas 252a through 252r) may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled to one or more transmission or reception components, such as one or more components of FIG. 2.

On the uplink, at the UE 120, a transmit processor 264 may receive and process data from a data source 262 and control information (for example, for reports that include RSRP, RSSI, RSRQ, or CQI) from the controller/processor 280. The transmit processor 264 may generate reference symbols for one or more reference signals. The symbols from the transmit processor 264 may be precoded by a TX MIMO processor 266 if applicable, further processed by the modems 254 (for example, for DFT-s-OFDM or CP-OFDM), and transmitted to the network entity 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, or the TX MIMO processor 266. The transceiver may be used by a processor (for example, the controller/processor 280) and the memory 282 to perform aspects of any of the processes described herein.

At the network entity 110, the uplink signals from UE 120 or other UEs may be received by the antennas 234, processed by the modem 232 (for example, a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network entity 110 may include a communication unit 244 and may communicate with the network controller 130 via the communication unit 244. The network entity 110 may include a scheduler 246 to schedule one or more UEs 120 for downlink or uplink communications. In some examples, the modem 232 of the network entity 110 may include a modulator and a demodulator. In some examples, the network entity 110 includes a transceiver. The transceiver may include any combination of the antenna(s) 234, the modem(s) 232, the MIMO detector 236, the receive processor 238, the transmit processor 220, or the TX MIMO processor 230. The transceiver may be used by a processor (for example, the controller/processor 240) and the memory 242 to perform aspects of any of the processes described herein.

In some aspects, the controller/processor 280 may be a component of a processing system. A processing system may generally be a system or a series of machines or components that receives inputs and processes the inputs to produce a set of outputs (which may be passed to other systems or components of, for example, the UE 120). For example, a processing system of the UE 120 may be a system that includes the various other components or subcomponents of the UE 120.

The processing system of the UE 120 may interface with one or more other components of the UE 120, may process information received from one or more other components (such as inputs or signals), or may output information to one or more other components. For example, a chip or modem of the UE 120 may include a processing system, a first interface to receive or obtain information, and a second interface to output, transmit, or provide information. In some examples, the first interface may be an interface between the processing system of the chip or modem and a receiver, such that the UE 120 may receive information or signal inputs, and the information may be passed to the processing system. In some examples, the second interface may be an interface between the processing system of the chip or modem and a transmitter, such that the UE 120 may transmit information output from the chip or modem. A person having ordinary skill in the art will readily recognize that the second interface also may obtain or receive information or signal inputs, and the first interface also may output, transmit, or provide information.

In some aspects, the controller/processor 240 may be a component of a processing system. A processing system may generally be a system or a series of machines or components that receives inputs and processes the inputs to produce a set of outputs (which may be passed to other systems or components of, for example, the network entity 110). For example, a processing system of the network entity 110 may be a system that includes the various other components or subcomponents of the network entity 110.

The processing system of the network entity 110 may interface with one or more other components of the network entity 110, may process information received from one or more other components (such as inputs or signals), or may output information to one or more other components. For example, a chip or modem of the network entity 110 may include a processing system, a first interface to receive or obtain information, and a second interface to output, transmit, or provide information. In some examples, the first interface may be an interface between the processing system of the chip or modem and a receiver, such that the network entity 110 may receive information or signal inputs, and the information may be passed to the processing system. In some examples, the second interface may be an interface between the processing system of the chip or modem and a transmitter, such that the network entity 110 may transmit information output from the chip or modem. A person having ordinary skill in the art will readily recognize that the second interface also may obtain or receive information or signal inputs, and the first interface also may output, transmit, or provide information.

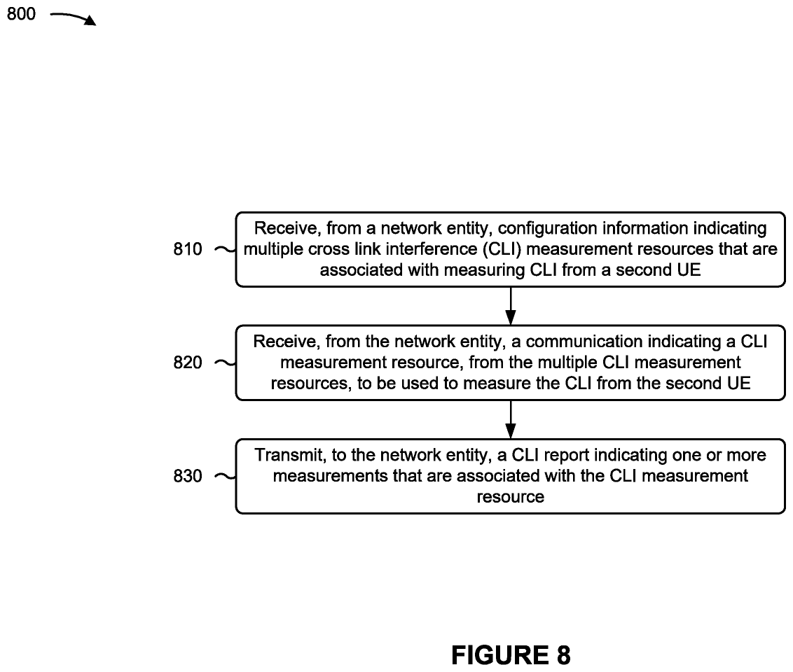

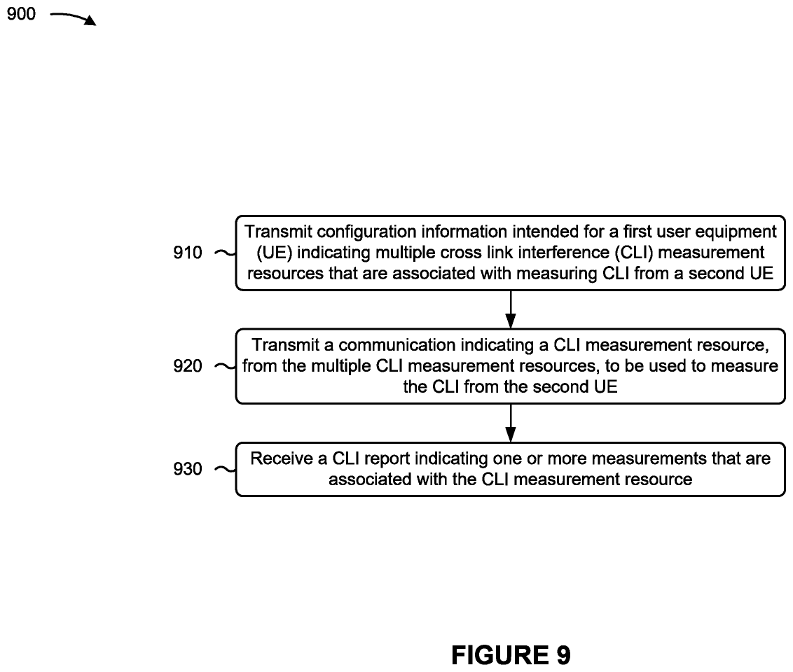

The controller/processor 240 of the network entity 110, the controller/processor 280 of the UE 120, or any other component(s) of FIG. 2 may perform one or more techniques associated with a CLI measurement resource indication, as described in more detail elsewhere herein. For example, the controller/processor 240 of the network entity 110, the controller/processor 280 of the UE 120, or any other component(s) (or combinations of components) of FIG. 2 may perform or direct operations of, for example, process 800 of FIG. 8, process 900 of FIG. 9, or other processes as described herein. The memory 242 and the memory 282 may store data and program codes for the network entity 110 and the UE 120, respectively. In some examples, the memory 242 and the memory 282 may include a non-transitory computer-readable medium storing one or more instructions (for example, code or program code) for wireless communication. For example, the one or more instructions, when executed (for example, directly, or after compiling, converting, or interpreting) by one or more processors of the network entity 110 or the UE 120, may cause the one or more processors, the UE 120, or the network entity 110 to perform or direct operations of, for example, process 800 of FIG. 8, process 900 of FIG. 9, or other processes as described herein. In some examples, executing instructions may include running the instructions, converting the instructions, compiling the instructions, or interpreting the instructions.

In some aspects, a first UE includes means for receiving, from a network entity, configuration information indicating multiple CLI measurement resources that are associated with measuring CLI from a second UE; means for receiving, from the network entity, a communication indicating a CLI measurement resource, from the multiple CLI measurement resources, to be used to measure the CLI from the second UE; or means for transmitting, to the network entity, a CLI report indicating one or more measurements that are associated with the CLI measurement resource. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network entity 110 includes means for transmitting configuration information intended for a first UE indicating multiple CLI measurement resources that are associated with measuring CLI from a second UE; means for transmitting a communication indicating a CLI measurement resource, from the multiple CLI measurement resources, to be used to measure the CLI from the second UE; or means for receiving a CLI report indicating one or more measurements that are associated with the CLI measurement resource. In some aspects, the means for the network entity to perform operations described herein may include, for example, one or more of the communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described with respect to the blocks may be implemented in a single hardware, software, or combination component or in various combinations of components. For example, the functions described with respect to the transmit processor 264, the receive processor 258, the TX MIMO processor 266, or another processor may be performed by or under the control of the controller/processor 280.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station.

An aggregated base station may be configured to utilize a radio protocol stack that is physically or logically integrated within a single RAN node (for example, within a single device or unit). A disaggregated base station may be configured to utilize a protocol stack that is physically or logically distributed among two or more units (such as a CU, one or more DUs, or one or more RUs). In some examples, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an JAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

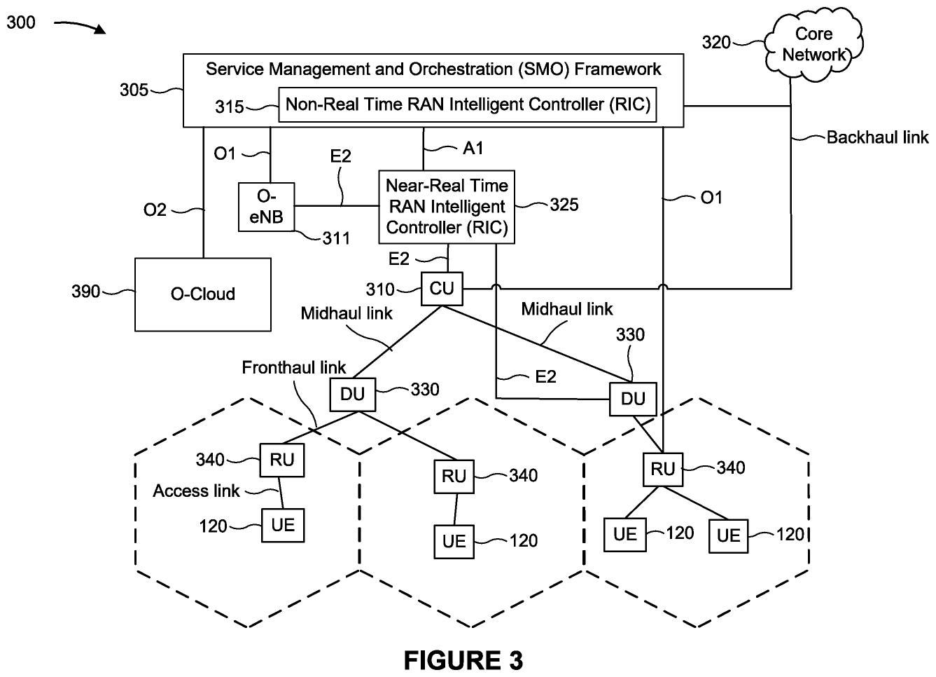

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as a RF transceiver), configured to receive or transmit signals, or both, over a wireless transmission medium to one or more of the other units.

In some aspects, the CU 310 may host one or more higher layer control functions. Such control functions can include RRC functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a MAC layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

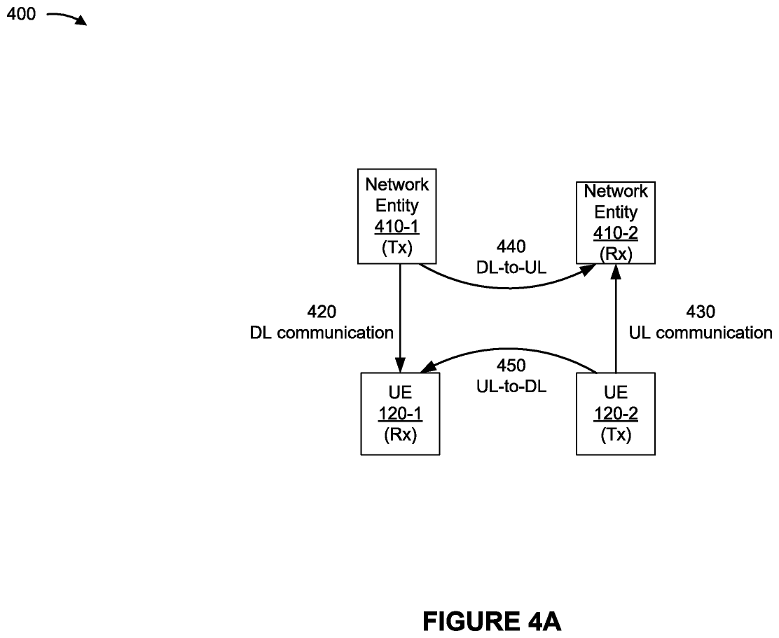

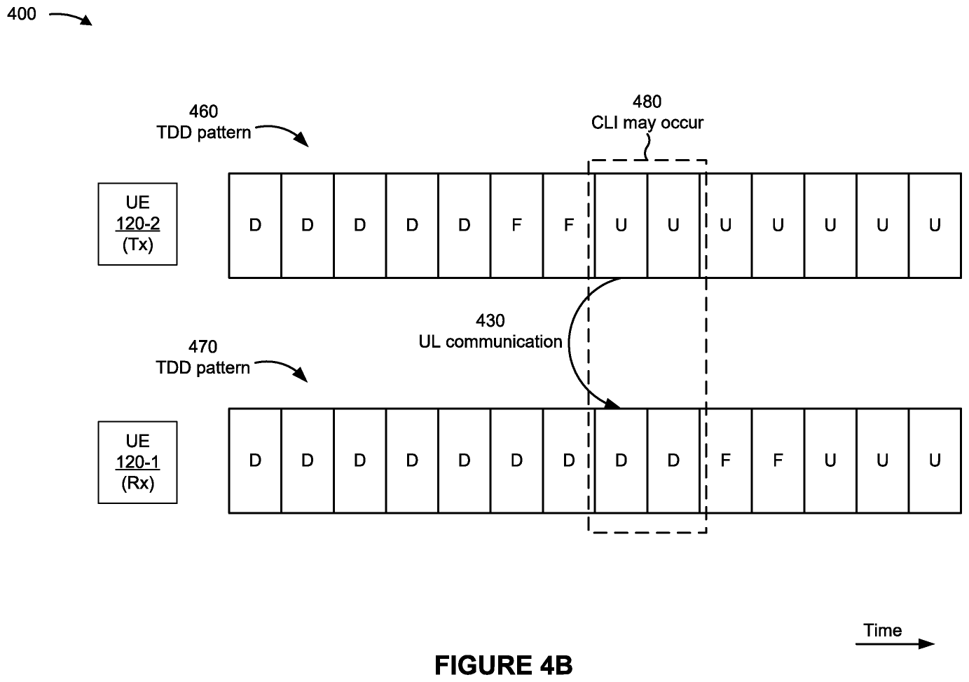

FIG. 4A is a diagram illustrating an example 400 relating to CLI detection and mitigation. In dynamic time division duplexing (TDD), the allocation of network resources to uplink and downlink may be dynamically modified depending on a traffic load. For example, a network entity may configure a TDD configuration (such as a TDD pattern) with more uplink transmission time intervals (TTIs) (such as frames, subframes, slots, mini-slots, or symbols, among other examples) for a UE 120 when the UE 120 has uplink data to transmit, and may configure a TDD configuration with more downlink TTIs for the UE 120 when the UE 120 has downlink data to receive. Example TDD configurations or TDD patterns are depicted in FIG. 4B. The TDD configuration may be dynamically configured to modify the allocation of uplink TTIs and downlink TTIs used for communication between a network entity and a UE 120.

As shown in FIG. 4A, when neighboring network entities 410 use different TDD configurations to communicate with UEs 120 (such as the UE 120 depicted in, and described in connection with, FIGS. 1-3), this may result in a downlink communication 420 between a first network entity 410-1 (such as a network entity depicted in, and described in connection with, FIGS. 1-3) and a first UE 120-1 in a same TTI as an uplink communication 430 between a second network entity 410-2 and a second UE 120-2. These communications in different transmission directions (for example, downlink vs. uplink) in the same TTI may interfere with one another, which may be referred to as CLI.

For example, as shown by reference number 440, the downlink communication 420 transmitted by the first network entity 410-1 may be received by the second network entity 410-2, and may interfere with reception, by the second network entity 410-2, of the uplink communication 430 from the second UE 120-2. This may be referred to as downlink-to-uplink (DL-to-UL) interference, network entity-to-network entity interference, base station to base station interference, or gNB-to-gNB interference, among other examples.

Further, as shown by reference number 450, the uplink communication 430 transmitted by the second UE 120-2 may be received by the first UE 120-1, and may interfere with reception, by the first UE 120-1, of the downlink communication 420 from the first network entity 410-1. This may be referred to as uplink-to-downlink (UL-to-DL) interference or UE-to-UE interference, among other examples. This UE-to-UE interference may occur or may increase when the first UE 120-1 and the second UE 120-2 are in close proximity, and may be avoided or mitigated by preventing scheduling of the UEs 120 in different transmission directions in the same TTI. CLI may be intra-cell CLI (for example, where the second UE 120-2 is in the same cell as the first UE 120-1) or inter-cell CLI (for example, where the first UE 120-1 and the second UE 120-2 are in different cells or adjacent cells). A UE experiencing the CLI (for example, the first UE 120-1 in the example depicted in FIG. 4A) may be referred to as a “victim UE” and a UE causing the CLI (for example, the second UE 120-2 in the example depicted in FIG. 4A) may be referred to as an “aggressor UE.”

FIG. 4B is a diagram illustrating TDD patterns potentially introducing CLI. For example, FIG. 4B depicts a TDD pattern 460 of the second UE 120-2 and a TDD pattern 470 of the first UE 120-1. The TDD pattern 460 or the TDD pattern 470 may include one or more downlink TTIs (shown as “D” in FIG. 4B) that are configured for downlink communications, such as the downlink communication 420. The TDD pattern 460 or the TDD pattern 470 may include one or more uplink TTIs (shown as “U” in FIG. 4B) that are configured for uplink communications, such as the uplink communication 430. In some examples, the TDD pattern 460 or the TDD pattern 470 may include one or more flexible TTIs (shown as “F” in FIG. 4B) that may be configured (by a network entity) for downlink communications or uplink communications.

As shown in FIG. 4B, and as described elsewhere herein, in some cases one or more uplink TTIs of the TDD pattern 460 may at least partially overlap in the time domain with one or more downlink TTIs of the TDD pattern 470. As a result, and as shown by reference number 480, CLI may occur in such scenarios because the second UE 120-2 may transmit one or more uplink communications at a time that at least partially overlaps with the first UE 120-1 receiving one or more downlink communications. Therefore, the one or more uplink communications may cause CLI at the first UE 120-1.

As described elsewhere herein, there are various scenarios in which a UE 120 (such as the first UE 120-1) may experience inter-cell CLI, intra-cell CLI, self-interference, or other interference that may degrade downlink reception performance at the UE 120. Accordingly, a network entity may configure the UE 120 to obtain measurements related to the interference experienced at the UE 120 and to report the measurements to the network entity (for example, to enable the network entity to select an appropriate downlink beam, resource allocation, or one or more other communication parameters to mitigate the interference experienced at the UE 120). For example, a network entity may configure the UE 120 with CLI measurement resources. “CLI measurement resource” may refer to one or more time domain or frequency domain resources that are used by a UE 120 to measure CLI or other interference. For example, the network entity may configure the UE 120 with a static or semi-static periodic CLI measurement resource using Layer 3 (L3) signaling (for example, radio resource control (RRC) signaling), and the UE 120 may report the interference measurements to the network entity using L3 messages. Once a CLI measurement resource is configured for a UE 120, the UE 120 may measure the CLI measurement resource as long as some conditions (for example, conditions common to all CLI measurement resources) are satisfied. In general, using L3 signaling to configure the CLI measurement resource and to provide the CLI measurement report that includes the interference measurements may provide a low-complexity solution and low control overhead. However, using static or semi-static RRC signaling lacks flexibility and carries a long latency to report CLI.

For example, in some cases, the first UE 120-1 may provide a CLI measurement report to a network entity (such as the first network entity 410-1) that indicates CLI caused by the UL communication 430 transmitted by the second UE 120-2. The network entity may use the CLI measurement report to determine modified air interface resource assignments (for example, modified gap frequency band sizes, modified frequency assignments, modified time assignments, or modified modulation and coding scheme (MCS) assignments, among other examples) for DL transmissions or UL transmissions by the first UE 120-1 to mitigate the CLI experienced by the first UE 120-1. In other words, based on or associated with the CLI measurement report, the network entity may select modified air interface resources to reduce CLI observed by the first UE 120-1, reduce recovery errors at the first UE 120-1, or increase data throughput at the first UE 120-1, among other examples.

A CLI measurement framework based on or associated with static or semi-static RRC signaling may generally support RSRP measurements and RSSI measurements using a sounding reference signal (SRS) resource configuration parameter (for example, SRS-ResourceConfigCLl-r16) to measure an RSRP associated with periodic SRS resources, or an RSSI resource configuration parameter (for example, RSSI-ResourceConfigCLl-r16) that configures the UE 120 to measure an RSSI based on or associated with energy in a given bandwidth or bandwidth part. In some cases, Layer 1 (L1) or Layer 2 (L2) CLI measurement or CLI reporting may be configured for the UE 120. L1 or L2 CLI reporting may be adaptable to track dynamic changes in interference conditions, L1/L2 signaling is associated with increased control signaling overhead and increased CLI management overhead at the network entity. For example, in an L2 CLI framework, a UE 120 (such as the UE 120-1) may be configured with a semi-persistent or periodic CLI measurement resource, and may report CLI measurements using L2 messages (for example, an uplink medium access control (MAC) control element (MAC-CE)). In another example, in an L1 CLI framework, a UE 120 (such as the UE 120-1) may be configured with an aperiodic, semi-persistent, or periodic CLI measurement resource, and may report CLI measurements using L1 messages (for example, a physical uplink shared channel (PUSCH) communication or a physical uplink control channel (PUCCH) communication).

A bandwidth part (BWP) may be a contiguous set of physical resource blocks (PRBs) on a given carrier. For example, a UE 120 may be configured with one or more active BWPs, one or more inactive BWPs, or one or more dormant BWPs. “Dormant BWP” may refer to a BWP that is not configured with a physical downlink control channel (PDCCH) (for example, a BWP that is not configured with PDCCH monitoring) and may be used for power saving, such as for when the UE 120 does not have traffic to transmit or has a small amount of traffic to transmit. A non-dormant BWP may be configured with PDCCH monitoring or may be associated with a higher data capacity than a dormant BWP. A non-dormant BWP may be associated with a different radio resource configuration than a radio resource configuration for a dormant BWP (for example, a non-dormant BWP may be associated with more radio resources than a dormant BWP). For example, the UE 120 may be configured to use a dormant BWP when the UE 120 does not have traffic to transmit or has a small amount of traffic to transmit and may be reconfigured to use a non-dormant BWP when the UE 120 has traffic to transmit. In other words, a switch between a dormancy state of the UE 120 (for example, in which one or more activities, such as PDCCH monitoring, of the UE 120 are reduced or eliminated) and a non-dormancy state of the UE 120 may be performed via a BWP switch, which may reduce latency associated with switching between the dormancy state and the non-dormancy state. Each cell may be associated with a respective one or more bandwidth part (BWP) configurations. The UE 120 may be associated with one or more active BWPs. “Active BWP” may refer to a BWP on which a UE is currently transmitting or receiving communications. At a given time, only one (for example, a single) BWP may be active for uplink communications or downlink communications. An active BWP may be a dormant BWP or a non-dormant BWP.

In some cases, CLI measurement or reporting may be confined to an active BWP of a UE 120. For example, CLI measurements may only be applicable for RRC connected intra-frequency measurements when a CLI measurement resource is configured within, or fully confined within, an active BWP of the UE 120. “Fully confined” or “configured within” may refer to frequency domain resources of the CLI measurement resource being included in frequency domain resources of the active BWP (for example, and not including any frequency domain resources that are not being included in the frequency domain resources of the active BWP). For example, CLI measurements may be applicable when an SRS-RSRP measurement resource is fully confined within a bandwidth of an active BWP for downlink communications. As another example, CLI measurements may only be applicable when a CLI-RSSI measurement resource is configured within the active BWP of the UE 120. In other words, a CLI measurement may only be effective in the active BWP of victim UE.

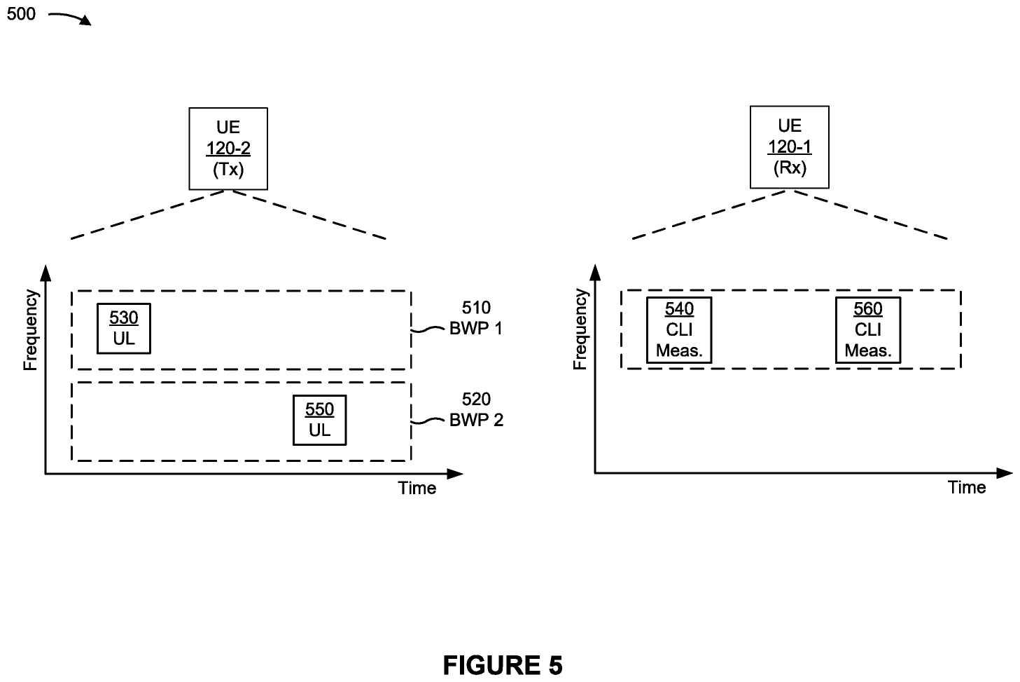

FIG. 5 is a diagram illustrating an example 400 relating to BWP switching associated with CLI measurements. As shown in FIG. 5, a UE (such as the UE 120 depicted in, and described in connection with, FIGS. 1-3 or the second UE 120-2 described herein in connection with FIGS. 4A and 4B) may be configured with a first BWP 510 and a second BWP 520. Over time, the second UE 120-2 may switch between using the first BWP 510 and the second BWP 520 for communications (for example, for power saving purposes or to increase throughput). For example, the first BWP 510 may be a non-dormant BWP and the second BWP 520 may be a dormant BWP.

As shown in FIG. 5, at a first time, the second UE 120-2 may transmit an uplink communication 530 (similar to the uplink communication 430) via the first BWP 510. Another UE (such as the UE 120 depicted in, and described in connection with, FIGS. 1-3 or the first UE 120-1 described herein, such as in connection with FIGS. 4A and 4B) may be configured with a CLI measurement resource 540. The CLI measurement resource 540 may be associated with frequency domain resources that are included in an active BWP of the first UE 120-1. The first UE 120-1 may measure the uplink communication 530 using the time-frequency resources associated with the CLI measurement resource 540 to obtain a CLI measurement associated with the second UE 120-2. As shown in FIG. 5, the active BWP of the first UE 120-1 may align (for example, may at least partially, or fully, overlap in the frequency domain) with the first BWP 510. Therefore, the first UE 120-1 may measure CLI associated with the second UE 120-2 using the CLI measurement resource 540.

In some cases, at a second time, the second UE 120-2 may switch to using the second BWP 520 for communications. For example, the second UE 120-2 may transmit an uplink communication 550 using frequency domain resources associated with the second BWP 520. However, the first UE 120-1 may not switch the active BWP and may continue to measure the semi-persistent or periodic CLI measurement resources associated with the active BWP (for example, a CLI measurement resource 560). However, because the frequency domain resources associated with the CLI measurement resource 560 may not align (for example, at least partially overlap with) the frequency domain resources of the second BWP 520, the measurement performed by the first UE 120-1 using the CLI measurement resource 560 may not provide meaningful information associated with CLI caused by the uplink communication 550 (transmitted by the second UE 120-2). In other words, a configured CLI measurement resource (for example, the CLI measurement resource 560) may not always map to (for example, align with) the active BWP of the aggressor UE (for example, the second BWP 520 of the second UE 120-2). As a result, the active BWP of the first UE 120-1 (for example, the victim UE) does not align with the active BWP of the of the second UE 120-2 (for example, the aggressor UE). Additionally, the active BWP of the victim UE does not provide any meaningful information regarding the aggressor UE's behavior (for example, measurements performed via CLI measurement resources included within the active BWP of the first UE 120-1 may not provide accurate CLI measurement information). Further, a reported CLI measurement (for example, that is obtained by measuring the CLI measurement resource 560) may reflect inaccurate CLI information associated with the second UE 120-2, resulting in a network entity making degraded or incorrect determinations associated with a configuration or resource allocation for the first UE 120-1.

Configuring new or additional CLI measurement resources each time an aggressor UE (such as the second UE 120-2) switches an active BWP may consume significant signaling overhead. Additionally, configuring multiple CLI measurement resources for a victim UE (for example, for the first UE 120-1) associated with the same aggressor UE (for example, associated with measuring CLI caused by transmission from the second UE 120-2) may consume processing and network resources. Additionally, this may consume an available CLI measurement resource budget (for example, defined, or otherwise fixed, by a wireless communication standard or a capability of the victim UE). If the victim UE is configured with multiple CLI measurement resources for the same aggressor UE, a resource availability associated with the victim UE measuring CLI associated with other aggressor UEs may be reduced. Therefore, the victim UE may measure CLI using CLI measurement resources that do not align in the frequency domain with an active BWP of the aggressor UE. Additionally, or alternatively, a network entity or the victim UE may consume significant signaling overhead, processing resources, network resources, or power resources, among other examples, associated with configuring, measuring, or reporting on, among other examples, multiple CLI measurement resources for the same aggressor UE.

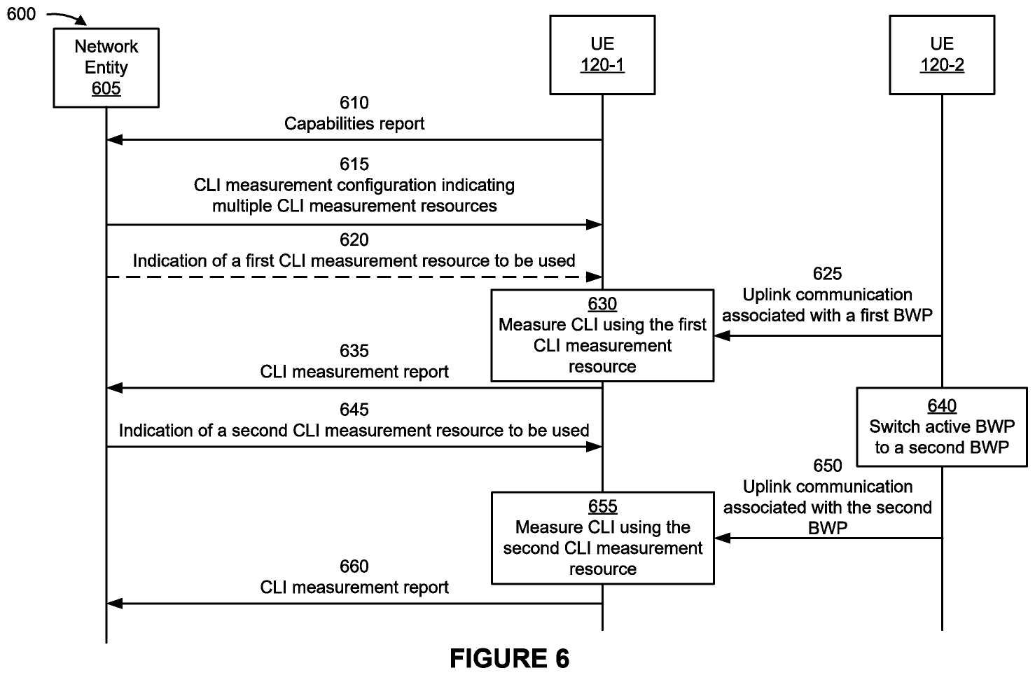

FIG. 6 is a diagram of an example 600 associated with a CLI measurement resource indication. As shown in FIG. 6, a network entity 605 (for example, the network entity 110, a base station, the network entity 410-1, a CU, a DU, or an RU) may communicate with a first UE 120-1 or a second UE 120-2 (such as UEs depicted in, and described in connection with, FIG. 1-3, 4A, 4B, or 5). In some aspects, the network entity 605, the first UE 120-1, and the second UE 120-2 may be part of a wireless network (for example, the wireless network 100). The network entity 605 and the first UE 120-1 may have established a wireless connection prior to operations shown in FIG. 6. In some aspects, the first UE 120-1 may be a victim UE and the second UE 120-2 may be an aggressor UE in a CLI scenario (such as depicted and described in connection with FIGS. 4A and 4B).

In some aspects, as shown by reference number 610, the first UE 120-1 may transmit a capabilities report (for example, a UE capability report). The network entity 605 may receive the capabilities report (for example, from the first UE 120-1 or from another network entity). In some aspects, the capabilities report may indicate UE support for CLI measurement resource switching. For example, the capabilities report may indicate that the first UE 120-1 supports being configured with multiple CLI measurement resources that are associated with a given aggressor UE (such as the second UE 120-2). The capabilities report may indicate that the first UE 120-1 supports dynamically switching CLI measurement resources, from the multiple CLI measurement resources, that are measured or monitored by the first UE 120-1 (for example, and not measuring or monitoring other CLI measurement resources from the multiple CLI measurement resources).

In some aspects, the capabilities report may indicate a quantity of CLI measurement resources that can be configured for the first UE 120-1 at a given time. As described in more detail elsewhere herein, the network entity 605 may configure the multiple CLI measurement resources as being associated with one or more CLI measurement resource sets (for example, where a CLI measurement resource set may include multiple CLI measurement resources). As described in more detail elsewhere herein, the first UE 120-1 may only monitor one or more CLI measurement resources from a given CLI measurement resource set at a time (for example, the first UE 120-1 may measure or monitor less than all of the multiple CLI measurement resources included in a CLI measurement resource set at a given time). In other words, the first UE 120-1 may only monitor a subset of CLI measurement resources from each CLI measurement resource set (for example, only some CLI measurement resources, but not all, from a CLI measurement resource set may be active at a time). Therefore, rather than indicating the quantity of CLI measurement resources that can be configured for the first UE 120-1 at a given time in terms of configured CLI measurement resources, the first UE 120-1 may indicate the quantity of CLI measurement resources that can be configured for the first UE 120-1 at a given time in terms of a quantity of CLI measurement resource sets that can be configured for the first UE 120-1 at a given time. For example, the quantity of CLI measurement resources that the first UE 120-1 is capable of monitoring or being configured with may be based on or associated with a quantity of CLI measurement resource sets that are configured for the first UE 120-1. This may increase a quantity of CLI measurement resources that can be configured for the first UE 120-1 while also ensuring that an overhead associated with measuring or monitoring the configured CLI measurement resources does not exceed a capability of the first UE 120-1 (for example, because not all of the configured CLI measurement resources will be measured or monitored by the first UE 120-1 at a given time).

In some aspects, the network entity 605 may determine configuration information, as described in more detail elsewhere herein, for the first UE 120-1 based on or associated with the capabilities report (for example, if the network entity 605 is a CU, DU, or a base station). For example, the network entity 605 may determine that the first UE 120-1 is to be configured with multiple CLI measurement resources that are associated with a given aggressor UE (such as the second UE 120-2) based on or associated with the capabilities report indicating UE support for a multiple CLI measurement resource configuration. Additionally, the network entity 605 may determine a quantity of CLI measurement resources or a quantity of CLI measurement resource sets to be configured for the first UE 120-1 based on or associated with the capabilities report.

As shown by reference number 615, the network entity 605 may transmit the configuration information. The first UE 120-1 may receive the configuration information (for example, from the network entity 605 or from another network entity). In some aspects, the first UE 120-1 may receive the configuration information via one or more of RRC signaling, one or more MAC control elements (MAC-CEs), or downlink control information (DCI), among other examples. In some aspects, the configuration information may include an indication of one or more configuration parameters (for example, already stored by the first UE 120-1 or previously indicated by the network entity 605 or another network entity to the first UE 120-1) for selection by the first UE 120-1, or explicit configuration information for the first UE 120-1 to use to configure the first UE 120-1, among other examples. In some aspects, the configuration information transmitted by the network entity 605 may be intended for the first UE 120-1. For example, if the network entity 605 is a DU, the DU may transmit the configuration information to an RU and the RU may transmit the configuration information to the first UE 120-1. As another example, if the network entity 605 is a CU, the CU may transmit the configuration information to a DU, the DU may transmit the configuration information to an RU, and the RU may transmit the configuration information to the first UE 120-1. As another example, if the network entity 605 is a base station (for example, an aggregated network entity) or an RU, the base station or the RU may transmit the configuration information directly to the first UE 120-1.

In some aspects, the configuration information may include a CLI measurement configuration or CLI reporting configuration. For example, the configuration information may indicate CLI measurement resources to be monitored or measured by the first UE 120-1 (for example, subject to one or more conditions, such as the CLI measurement resource being included in an active BWP of the first UE 120-1). In some aspects, the configuration information may indicate multiple CLI measurement resources that are associated with measuring CLI from the second UE 120-2. In other words, the network entity 605 may configure multiple CLI resources for the first UE 120-1 that are available to be used to measure CLI associated with the same aggressor UE (such as the second UE 120-2).

In some aspects, the multiple CLI resources may be included in the same CLI measurement resource set. For example, the configuration information may indicate that each of the multiple CLI measurement resources is associated with the same resource set. In some aspects, the configuration information may indicate a configuration for each of the multiple CLI measurement resources. The configuration may indicate the same resource set index value or identifier for each of the multiple CLI measurement resources (for example, indicating that the multiple CLI resources are included in the same CLI measurement resource set). The network entity 605 may determine or define a resource set of multiple CLI measurement resources. CLI measurement resource switching, as described in more detail elsewhere herein, triggered among resources within the same set (for example, the resource set may be configured by the network, such as by the network entity 605, by associating multiple CLI measurement resources with a same set index or resources are defined in the same resource set body).

In some aspects, the multiple CLI resources may be associated with different BWPs configured for the second UE 120-2. For example, the multiple CLI resources may include a first CLI measurement resource corresponding to a first uplink bandwidth part associated with the second UE 120-2 and a second CLI measurement resource corresponding to a second uplink bandwidth part associated with the second UE 120-2, among other examples. For example, the network entity 605 may configure one or more CLI measurement resources corresponding to a non-dormant BWP associated with the second UE 120-2. Additionally, the network entity 605 may configure one or more CLI measurement resources corresponding to a dormant BWP associated with the second UE 120-2. As used herein, a CLI measurement resource “corresponding to” or “aligning with” a BWP may refer to frequency domain resources associated with the CLI measurement resource at least partially overlapping with frequency domain resources associated with the BWP. For example, two CLI measurement resources can be defined (such as by the network entity 605 via the configuration information) within a CLI measurement resource set, with each CLI measurement resource corresponding to respective BWPs (such as the dormant BWP and the non-dormant BWP) of the second UE 120-2 (the aggressor UE). If the second UE 120-2 (the aggressor UE) supports more than two BWPs, the network (for example, the network entity 605) may configure CLI measurement resources for all the BWPs configured for the second UE 120-2. This may avoid frequent RRC configuration updates and reduce an RRC signaling overhead associated with configuring CLI measurement resources when an aggressor UE is capable of BWP switching.

In some aspects, the network entity 605 may define or indicate one or more subsets associated with the CLI measurement resource set. A subset may include one or more CLI measurement resources from the multiple CLI measurement resources. For example, the configuration information may indicate that a first one or more CLI measurement resources, from the multiple CLI measurement resources, are associated with a first subset of the same resource set. The configuration information may indicate that a second one or more CLI measurement resources, from the multiple CLI measurement resources, are associated with a second subset of the same resource set. For example, the network entity 605 may define resource subsets each with multiple CLI measurement resources within the same resource set. In some aspects, a subset is configured by the network entity 605 by associating CLI measurement resources with a same sub-set index or resources are defining the CLI measurement resources in the same resource sub-set body within the resource set.

In some aspects, a first subset and a second subset associated with the same CLI measurement resource set may be associated with the same uplink bandwidth part associated with the second UE 120-2. For example, the second UE 120-2 may be associated with different uplink transmission patterns in the same active BWP, such as a first uplink transmission pattern associated with dynamic grant (for example, scheduled by DCI) uplink communications and a second uplink transmission pattern associated with configured grant (for example, semi-persistent scheduling or periodic) uplink communications. CLI measurement resource(s) associated with respective subsets may correspond to different uplink transmission patterns within the same active BWP of the second UE 120-2. For example, a first subset of CLI measurement resource(s) (such as a first CLI-RSSI resource) may be associated with dynamically scheduled uplink communications associated with a BWP of the second UE 120-2. A second subset of CLI measurement resource(s) (such as a second CLI-RSSI resource) may be associated with configured grant uplink communications associated with the BWP of the second UE 120-2.

In some aspects, the CLI measurement resource set or a subset of CLI measurement resources may be defined separately for different CLI measurement types, such as RSSI-based CLI measurements or RSRP-based CLI measurements, among other examples. For example, the configuration information may indicate at least one of a CLI measurement resource set or one or more subsets, associated with the CLI measurement resource set, for the multiple CLI measurement resources, corresponding to a given CLI measurement type. As another example, the CLI measurement resource set or a subset of CLI measurement resources may be defined jointly for all CLI measurement types. For example, the configuration information may indicate at least one of a CLI measurement resource set or one or more subsets, associated with the CLI measurement resource set, for the multiple CLI measurement resources, corresponding to all CLI measurement types.

In some aspects, the configuration information may indicate a mapping between information (for example, bits) included in a communication (for example, a dynamic CLI measurement switch triggering indication, as described in more detail elsewhere herein such as in connection with reference numbers 620 and 645) and respective CLI measurement resources of the multiple CLI measurement resources. As another example, the configuration information may indicate a mapping between information (for example, bits) included in the communication and respective subsets of a resource set associated with the multiple CLI measurement resources. For example, the configuration information may map, or associate, one or more bits to a CLI measurement resource set to enable the network entity 605 to dynamically indicate a CLI measurement resource or a subset of CLI measurement resources included in the CLI measurement resource set. For example, two bits may be used for the mapping and the mapping may indicate that a value of “00” for the two bits is associated with a first CLI measurement resource or first subset, a value of “01” for the two bits is associated with a second CLI measurement resource or second subset, a value of “10” for the two bits is associated with a third CLI measurement resource or third subset, and a value of “11” for the two bits is associated with a fourth CLI measurement resource or fourth subset. Other techniques also may be used by the communication (for example, a dynamic CLI measurement switch triggering indication, as described in more detail elsewhere herein such as in connection with reference numbers 620 and 645) to indicate a given configured CLI measurement resource or subset. The mapping (such as a starting bit location and quantity of the bits for a CLI measurement resource set) may be configured by the network entity 605 via the configuration information. For example, if there are only two CLI measurement resource or two CLI measurement resource subsets in a CLI measurement resource set, one bit may be used to select one CLI measurement resource or one subset from the CLI measurement resource set (such as a value of “0” for the bit indicating a first CLI measurement resource and a value of “1” for the bit indicating a second CLI measurement resource).

In some aspects, the network entity 605 may track or count a quantity of CLI measurement resources that are used or available to be used by the first UE 120-1 (for example, the method of tracking or counting may be defined, or otherwise fixed, by a wireless communication standard, such as the 3GPP). In some aspects, as described in more detail elsewhere herein, less than all of the multiple CLI measurement resources that are configured for the UE 120 may be “active” at a given time (for example, the network entity 605 may indicate which CLI measurement resources are to be measured or monitored by the first UE 120-1 and the other CLI measurement resources, from the multiple CLI measurement resources may not be measured or monitored by the first UE 120-1). Therefore, when the CLI measurement resources are counted by the network entity 605, the network entity 605 may only count the active CLI measurement resources for the first UE 120-1. In other words, a quantity of CLI measurement resources that are counted for the first UE 120-1 may be associated with CLI measurement resources, including the CLI measurement resource, that are activated by the network entity 605 or another network entity (for example, by a dynamic CLI measurement switch triggering indication, as described in more detail elsewhere herein such as in connection with reference numbers 620 and 645).

For example, the network entity 605 may track or count a quantity of CLI measurement resources that are active for the first UE 120-1 in a given slot or across multiple slots. In other words, the CLI measurement resources that are counted are associated with a single slot or multiple slots. In some aspects, the network entity 605 may separately count CLI measurement resources that are associated with different CLI measurement resource types (for example, may separately count RSSI-based CLI measurement resources and SRS RSRP-based CLI measurement resources). For example, the CLI measurement resources that are counted are associated with a given CLI measurement type. In some other aspects, the network entity 605 may jointly count CLI measurement resources that are associated with different CLI measurement resource types. The network entity 605 may ensure that the quantity of CLI measurement resources that are active for the first UE 120-1 is less than or equal to a threshold quantity of CLI measurement resources (for example, where the threshold quantity is associated with a capability of the first UE 120-1 or is defined, or otherwise fixed, by a wireless communication standard, such as the 3GPP).

The first UE 120-1 may configure itself using the configuration information. In some aspects, the first UE 120-1 may be configured to perform one or more operations described herein associated with or based on the configuration information.

In some aspects, as shown by reference number 620, the network entity 605 may transmit a communication indicating a first CLI measurement resource, from the multiple CLI measurement resources (for example, that are configured via the configuration information), to be used by the first UE 120-1 to measure the CLI from the second UE 120-2. The first UE 120-1 may receive the communication (for example, from the network entity 605 or from another network entity). The communication may be a dynamic CLI measurement switch triggering indication. For example, the communication may trigger the first UE 120-1 to measure or monitor the first CLI measurement resource (or first subset of CLI measurement resources) from multiple configured CLI measurement resources (such as from a configured CLI measurement resource set).

In some aspects, the communication may be, or may be included in, a MAC-CE communication. In some other aspects, the communication may be, or may be included in, a downlink control channel communication, such as a physical downlink control channel (PDCCH) communication. For example, the communication may be, or may be included in, a DCI communication. For example, the communication may be received by the first UE 120-1 using Layer 1 (L1) signaling, Layer 2 (L2) signaling, or another type of dynamic signaling.

In some aspects, the communication may indicate an identifier or an index value that is associated with, or mapped to, a given CLI measurement resource (or a subset of CLI measurement resources) from the multiple CLI measurement resources configured via the configuration information. For example, as described elsewhere herein, the configuration information may indicate a mapping of the multiple CLI measurement resources to respective identifiers of index values. The first UE 120-1 may identify the CLI measurement resource (or a subset of CLI measurement resources) indicated by the communication based on or associated with the identifier or the index value and the mapping indicated by the configuration information.

In some aspects, the network entity 605 may determine the first CLI measurement resource (or a first subset of CLI measurement resources) to be indicated by the communication based on or associated with an BWP that is currently active for the second UE 120-2. For example, the network entity 605 may identify an active BWP for the second UE 120-2 at a given time. The network entity 605 may identify a CLI measurement resource (or a subset of CLI measurement resources) from the multiple CLI measurement resources that is associated with, or aligns with (for example, in the frequency domain), the active BWP for the second UE 120-2. The network entity 605 may indicate the identified CLI measurement resource (or a subset of CLI measurement resources) in the communication to cause the first UE 120-1 to monitor or measure a CLI measurement resource that is associated with, or aligns with (for example, in the frequency domain), the active BWP for the second UE 120-2.

In some aspects, after receiving the configuration information and prior to receiving a dynamic CLI measurement switch triggering indication (as described in connection with reference number 620), the first UE 120-1 may monitor or measure a default CLI measurement resource from the multiple CLI measurement resources. The default CLI measurement resource may be defined by the configuration information. In some aspects, the default CLI measurement resource may be defined, or otherwise fixed, by a wireless communication standard, such as the 3GPP. In some aspects, the default CLI measurement resource, from the multiple CLI measurement resources, may be identified by the first UE 120-1 based on or associated with respective identifiers or index values of the multiple CLI measurement resources. For example, the default CLI measurement resource may be the CLI measurement resource, from the multiple CLI measurement resources, that is associated with a certain identifier or index value (such as a lowest index value, a highest index value, or another identified index value). In some other aspects, the first UE 120-1 may not measure or monitor any of the multiple CLI measurement resources until a dynamic CLI measurement switch triggering indication (as described in connection with reference number 620) is received by the first UE 120-1. This may resolve ambiguity as to which CLI measurement resource(s), from the multiple configured CLI measurement resources, is to be measured or monitored by the first UE 120-1 prior to the first UE 120-1 receiving a dynamic CLI measurement switch triggering indication.

As shown by reference number 625, the second UE 120-2 may transmit an uplink communication associated with a first BWP (for example, the active uplink BWP of the second UE 120-2). For example, the second UE 120-2 may transmit one or more uplink signals via the first BWP. The one or more uplink signals may be dynamically scheduled (for example, by the network entity 605 or another network entity). In some aspects, the one or more uplink signals may be periodic or semi-persistent scheduled communications, such as configured grant uplink communications. The first UE 120-1 may receive the one or more uplink signals. In some aspects, the one or more uplink signals may include an SRS. The one or more uplink signals may be associated with a first CLI measurement resource (for example, that is indicated as being activated by the communication received by the first UE 120-1 as described in connection with reference number 620). In other words, the first CLI measurement resource may be associated with time domain or frequency domain resources that at least partially overlap with the time domain or frequency resources used by the second UE 120-2 to transmit the one or more uplink signals.

As shown by reference number 630, the first UE 120-1 may measure the one or more uplink signals to measure the CLI caused by uplink transmissions from the second UE 120-2. The first UE 120-1 may measure the CLI using the first CLI measurement resource. For example, the first UE 120-1 may measure the one or more uplink signals to obtain one or more measurements (one or more CLI measurements) that are associated with the CLI measurement resource. The one or more measurements may be RSRP-based CLI measurements, RSSI-based CLI measurements, or another type of CLI measurement. The first UE 120-1 may continue to monitor or measure the first CLI measurement resource (for example, in a periodic or semi-persistent manner) until the network entity 605 indicates that the UE 120-1 is to switch to another CLI measurement resource from the CLI measurement resource set associated with the first CLI measurement resource. In other words, the first UE 120-1 may use the first CLI measurement resource to measure CLI associated with the second UE 120-2 until the network entity 605 indicates to switch to another CLI measurement resource to measure CLI associated with the second UE 120-2. Additionally, or alternatively, the first UE 120-1 may switch to another CLI measurement resource to measure CLI associated with the second UE 120-2 associated with detecting a condition or triggering event (for example, such as a measurement of the CLI satisfying a threshold, or a difference between measured CLI at a first time and a second time satisfying a threshold, among other examples).

As shown by reference number 635, the first UE 120-1 may transmit a CLI report (for example, a CLI measurement report) indicating the one or more measurements that are associated with the first CLI measurement resource. In some aspects, the CLI report may be associated with a CLI measurement resource set that includes the first CLI measurement resource. For example, rather than the CLI report being associated with a given CLI resource (for example, the first CLI measurement resource), the CLI report may be associated with the CLI measurement resource set. For example, the first UE 120-1 may include an identifier of the CLI measurement resource set in the CLI report (in addition to, or instead of, an identifier of the first CLI measurement resource). In other words, CLI measurement reporting may be performed on a CLI measurement resource set basis, rather than on a CLI measurement resource basis. Additionally, or alternatively, the CLI report may be associated with a subset, from the CLI measurement resource set, that includes the first CLI measurement resource. For example, the first UE 120-1 may include an identifier of the subset in the CLI report (in addition to, or instead of, an identifier of the first CLI measurement resource). In other words, CLI measurement reporting may be performed on a subset of CLI measurement resources basis, rather than on a CLI measurement resource basis.

The network entity 605 may receive the CLI report (for example, from the first UE 120-1 or from another network entity). The network entity 605 may use the CLI report to determine modified air interface resource assignments (for example, modified gap frequency band sizes, modified frequency assignments, modified time assignments, or MCS assignments, among other examples) for downlink transmissions or uplink transmissions by the first UE 120-1 to mitigate the CLI experienced by the first UE 120-1. In other words, based on or associated with the CLI report, the network entity 605 may select modified air interface resources to reduce CLI observed by the first UE 120-1, reduce recovery errors at the first UE 120-1, or increase data throughput at the first UE 120-1, among other examples.

As shown by reference number 640, the second UE 120-2 may switch an active BWP from the first BWP to a second BWP. For example, the second UE 120-2 may switch the BWP used for uplink communications from the first BWP to the second BWP. In some aspects, the second UE 120-2 may switch the active BWP to the second BWP associated with receiving an indication from the network entity 605 or another network entity. Alternatively, the second UE 120-2 may switch the active BWP to the second BWP associated with detecting a condition associated with switching BWPs.

The network entity 605 may detect that the second UE 120-2 has switched the active BWP from the first BWP to the second BWP. For example, the network entity 605 may detect that the second UE 120-2 has switched the active BWP from the first BWP to the second BWP associated with transmitting an indication to the second UE 120-2 to switch the active BWP to the second BWP. As another example, the network entity 605 may detect that the second UE 120-2 has switched the active BWP from the first BWP to the second BWP associated with detecting the condition associated with switching BWPs. As another example, the network entity 605 may detect that the second UE 120-2 has switched the active BWP from the first BWP to the second BWP associated with receiving an indication from another network entity indicating that the second UE 120-2 has switched the active BWP to the second BWP.

Associated with detecting that the second UE 120-2 has switched the active BWP from the first BWP to the second BWP, the network entity 605 may determine a second CLI measurement resource (or a second subset of CLI measurement resources) from the CLI measurement resource set (for example, from the multiple CLI measurement resources) to be indicated by activated for the first UE 120-1 associated with the second BWP that is currently active for the second UE 120-2. For example, the network entity 605 may identify a CLI measurement resource (or a subset of CLI measurement resources) from the multiple CLI measurement resources that is associated with, or aligns with (for example, in the frequency domain), the second BWP for the second UE 120-2. The network entity 605 may indicate the identified CLI measurement resource (or subset of CLI measurement resources) in another communication to cause the first UE 120-1 to monitor or measure the second CLI measurement resource that is associated with, or aligns with (for example, in the frequency domain), the second BWP of the second UE 120-2. Additionally, or alternatively, the network entity 605 may determine that the second CLI measurement resource is to be used by the first UE 120-1 to measure the CLI based on or associated with a current uplink transmission pattern associated with the second UE 120-2.

For example, as shown by reference number 645, the network entity 605 may transmit another communication indicating another CLI measurement resource (the second CLI measurement resource), from the multiple CLI measurement resources, to be used to measure the CLI from the second UE 120-2. The communication may be similar to, or the same as, the communication described herein, such as in connection with reference number 620. The first UE 120-1 may receive the communication (for example, from the network entity 605 or from another network entity). The communication may be a dynamic CLI measurement switch triggering indication. For example, the communication may trigger the first UE 120-1 to measure or monitor the second CLI measurement resource (or second subset of CLI measurement resources) from the multiple configured CLI measurement resources (such as from the configured CLI measurement resource set that is associated with the second UE 120-2). For example, the first CLI measurement resource and the second CLI measurement resource may be included in the same CLI measurement resource set. Based on or associated with receiving the communication indicating that the first UE 120-1 is to monitor or measure the second CLI measurement resource, the first UE 120-1 may stop or refrain from monitoring or measuring the first CLI measurement resource. This may conserve processing resource or power resources, among other examples, that would have otherwise been used by the first UE 120-1 to monitor and measure both the first CLI measurement resource and the second CLI measurement resource for the same aggressor UE (for example, for the second UE 120-2).

As shown by reference number 650, the second UE 120-2 may transmit an uplink communication associated with the second BWP (for example, the active uplink BWP of the second UE 120-2). For example, the second UE 120-2 may transmit one or more uplink signals via the second BWP. The one or more uplink signals may be dynamically scheduled (for example, by the network entity 605 or another network entity). In some aspects, the one or more uplink signals may be periodic or semi-persistent scheduled communications, such as configured grant uplink communications. The first UE 120-1 may receive the one or more uplink signals. In some aspects, the one or more uplink signals may include an SRS. The one or more uplink signals may be associated with the second CLI measurement resource (for example, that is indicated as being activated by the communication received by the first UE 120-1 as described in connection with reference number 645). In other words, the second CLI measurement resource may be associated with time domain or frequency domain resources that at least partially overlap with the time domain or frequency resources used by the second UE 120-2 to transmit the one or more uplink signals.

As shown by reference number 655, the first UE 120-1 may measure the one or more uplink signals to measure the CLI caused by uplink transmissions from the second UE 120-2. The first UE 120-1 may measure the CLI using the second CLI measurement resource. For example, the first UE 120-1 may measure the one or more uplink signals to obtain one or more measurements (one or more CLI measurements) that are associated with the second CLI measurement resource. The one or more measurements may be RSRP-based CLI measurements, RSSI-based CLI measurements, or another type of CLI measurement. The first UE 120-1 may continue to monitor or measure the second CLI measurement resource (for example, in a periodic or semi-persistent manner) until the network entity 605 indicates that the UE 120-1 is to switch to another CLI measurement resource from the CLI measurement resource set associated with the first CLI measurement resource. Additionally, or alternatively, the first UE 120-1 may switch to another CLI measurement resource to measure CLI associated with the second UE 120-2 associated with detecting a condition or triggering event (for example, such as a measurement of the CLI satisfying a threshold, or a difference between measured CLI at a first time and a second time satisfying a threshold, among other examples).

As shown by reference number 660, the first UE 120-1 may transmit a CLI report (for example, a CLI measurement report) indicating the one or more measurements that are associated with the second CLI measurement resource. In some aspects, the CLI report may be associated with the CLI measurement resource set that includes the second CLI measurement resource (for example, where the first CLI measurement resource is also included in the CLI measurement resource set). In a similar manner as described elsewhere herein, the CLI report may be associated with the CLI measurement resource set. For example, the first UE 120-1 may include an identifier of the CLI measurement resource set in the CLI report (in addition to, or instead of, an identifier of the second CLI measurement resource).

The network entity 605 may receive the CLI report (for example, from the first UE 120-1 or from another network entity). The network entity 605 may use the CLI report to determine modified air interface resource assignments (for example, modified gap frequency band sizes, modified frequency assignments, modified time assignments, or MCS assignments, among other examples) for downlink transmissions or uplink transmissions by the first UE 120-1 to mitigate the CLI experienced by the first UE 120-1. In other words, based on or associated with the CLI report, the network entity 605 may select modified air interface resources to reduce CLI observed by the first UE 120-1, reduce recovery errors at the first UE 120-1, or increase data throughput at the first UE 120-1, among other examples. By enabling the first UE 120-1 to switch CLI measurement resources to align with the active BWP of the second UE 120-2, the reported CLI measurements may provide more insightful or more accurate CLI information associated with the second UE 120-2. As a result, the determinations made by the network entity 605 based on or associated with the reported CLI information may be improved. This may improve a communication performance, efficiency, or throughput, among other examples, of the first UE 120-1.

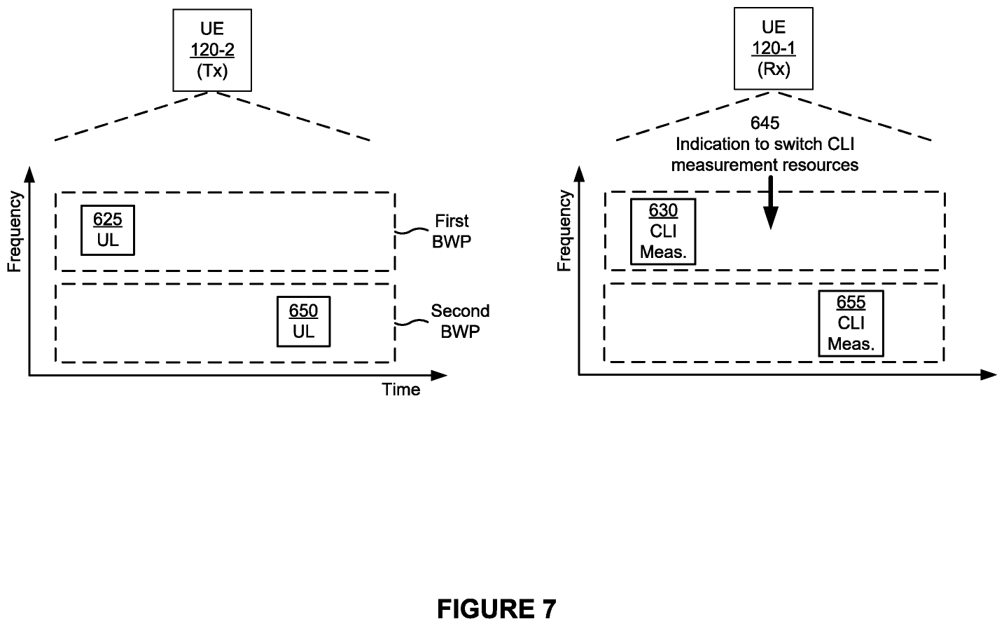

FIG. 7 is a diagram of an example associated with a CLI measurement resource indication. As shown in FIG. 7, the first UE 120-1 and the second UE 120-2 (for example, the first UE 120-1 and the second UE 120-2 depicted and described in connection with FIG. 6) may be associated with a CLI measurement scenario, in a similar manner as described elsewhere herein. For example, as described in connection with reference number 625, the second UE 120-2 may transmit one or more uplink signals via the first BWP associated with the second UE 120-2 (for example, using a first set of frequency domain resources). The first BWP may be the active BWP of the second UE 120-2 at a time at which the one or more uplink signals are transmitted.

The first UE 120-1 may measure CLI caused by the transmission of the one or more uplink signals using a first CLI measurement resource (for example, in a similar manner as described in connection with FIG. 6 and reference number 630). For example, as described in more detail elsewhere herein, the first UE 120-1 may be configured with multiple CLI measurement resources (for example, a CLI measurement resource set) that are associated with measuring CLI caused by uplink transmissions from the second UE 120-2. The first CLI measurement resource may align with (for example, at least partially overlap in the frequency domain with) the first BWP of the second UE 120-2. As a result, the first UE 120-1 may obtain accurate CLI measurement information associated with the second UE 120-2 while the first BWP is active for the second UE 120-2 using the first CLI measurement resource.

At a later time, the second UE 120-2 may switch an active uplink BWP to the second BWP, in a similar manner as described elsewhere herein. For example, the second UE 120-2 may switch to using a second set of frequency domain resources for uplink communications. In a similar manner as described herein, such as in connection with FIG. 6 and reference number 645, the first UE 120-1 may receive an indication to switch CLI measurement resources to a second CLI measurement resource. The first UE 120-1 may receive the indication from a network entity, such as the network entity 605. Alternatively, the first UE 120-1 may receive the indication from the second UE 120-2 or another UE. The second CLI measurement resource may align with (for example, at least partially overlap in the frequency domain with) the first BWP of the second UE 120-2.

In a similar manner as described in connection with reference number 650, the second UE 120-2 may transmit one or more uplink signals via the second BWP associated with the second UE 120-2 (for example, using a second set of frequency domain resources). The first UE 120-1 may measure CLI caused by the transmission of the one or more uplink signals using the second CLI measurement resource (for example, in a similar manner as described in connection with FIG. 6 and reference number 655). As a result, the first UE 120-1 may dynamically switch CLI measurement resources used to measure CLI caused by uplink transmissions by the second UE 120-2 in order to align (in the frequency domain) the CLI measurement resource used with the active BWP of the second UE 120-2.

FIG. 8 is a diagram illustrating an example process 800 performed, for example, by a UE. The process 800 is an example where the UE (for example, the first UE 120-1) performs operations associated with a CLI measurement resource indication.

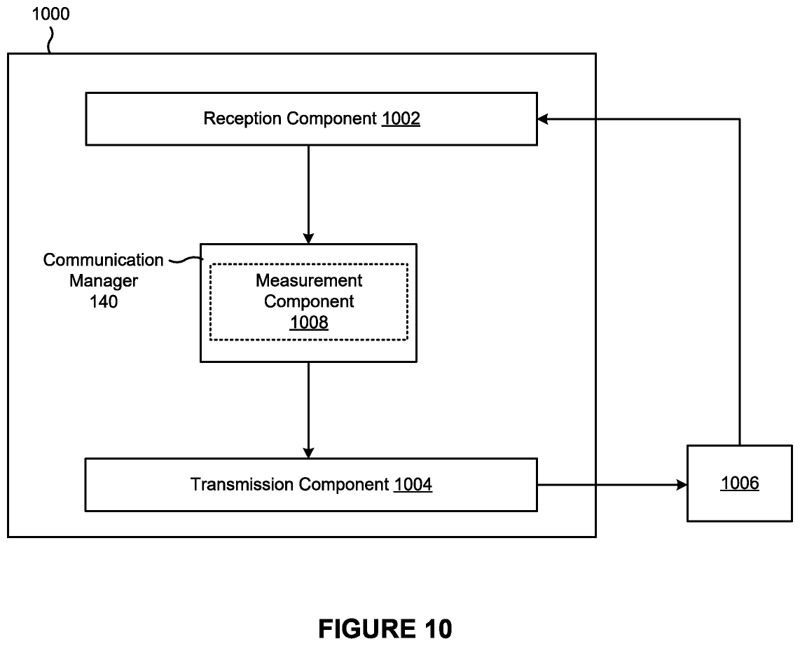

As shown in FIG. 8, in some aspects, the process 800 may include receiving, from a network entity, configuration information indicating multiple CLI measurement resources that are associated with measuring CLI from a second UE (block 810). For example, the UE (such as by using communication manager 140 or reception component 1002, depicted in FIG. 10) may receive, from a network entity, configuration information indicating multiple CLI measurement resources that are associated with measuring CLI from a second UE.

As further shown in FIG. 8, in some aspects, the process 800 may include receiving, from the network entity, a communication indicating a CLI measurement resource, from the multiple CLI measurement resources, to be used to measure the CLI from the second UE (block 820). For example, the UE (such as by using communication manager 140 or reception component 1002, depicted in FIG. 10) may receive, from the network entity, a communication indicating a CLI measurement resource, from the multiple CLI measurement resources, to be used to measure the CLI from the second UE.

As further shown in FIG. 8, in some aspects, the process 800 may include transmitting, to the network entity, a CLI report indicating one or more measurements that are associated with the CLI measurement resource (block 830). For example, the UE (such as by using communication manager 140 or transmission component 1004, depicted in FIG. 10) may transmit, to the network entity, a CLI report indicating one or more measurements that are associated with the CLI measurement resource.

The process 800 may include additional aspects, such as any single aspect or any combination of aspects described in connection with the process 800 or in connection with one or more other processes described elsewhere herein.

In a first additional aspect, the process 800 includes receiving, from the network entity, another communication indicating another CLI measurement resource, from the multiple CLI measurement resources, to be used to measure the CLI from the second UE, and transmitting, to the network entity, another CLI report indicating one or more measurements that are associated with the other CLI measurement resource.

In a second additional aspect, alone or in combination with the first aspect, the process 800 includes receiving, from the second UE, one or more signals that are associated with the CLI measurement resource, and measuring the one or more signals to obtain the one or more measurements.

In a third additional aspect, alone or in combination with one or more of the first and second aspects, the communication is at least one of a MAC-CE communication, a downlink control channel communication, or a DCI communication.

In a fourth additional aspect, alone or in combination with one or more of the first through third aspects, the CLI measurement resource corresponds to an active uplink bandwidth part associated with the second UE.

In a fifth additional aspect, alone or in combination with one or more of the first through fourth aspects, the CLI measurement resource is a first CLI measurement resource, and where the multiple CLI measurement resources include the first CLI measurement resource corresponding to a first uplink bandwidth part associated with the second UE and a second CLI measurement resource corresponding to a second uplink bandwidth part associated with the second UE.

In a sixth additional aspect, alone or in combination with one or more of the first through fifth aspects, the configuration information indicates that each of the multiple CLI measurement resources is associated with a same resource set.

In a seventh additional aspect, alone or in combination with one or more of the first through sixth aspects, the configuration information indicates that a first one or more CLI measurement resources, from the multiple CLI measurement resources, are associated with a first subset of the same resource set, and that a second one or more CLI measurement resources, from the multiple CLI measurement resources, are associated with a second subset of the same resource set.

In an eighth additional aspect, alone or in combination with one or more of the first through seventh aspects, the first subset and the second subset are associated with a same uplink bandwidth part associated with the second UE.

In a ninth additional aspect, alone or in combination with one or more of the first through eighth aspects, the configuration information indicates at least one of a resource set or one or more subsets, associated with the resource set, for the multiple CLI measurement resources, corresponding to a CLI measurement type.

In a tenth additional aspect, alone or in combination with one or more of the first through ninth aspects, the configuration information indicates at least one of a resource set or one or more subsets, associated with the resource set, for the multiple CLI measurement resources, corresponding to all CLI measurement types.

In an eleventh additional aspect, alone or in combination with one or more of the first through tenth aspects, the configuration information indicates a mapping between information included in the communication and respective CLI measurement resources of the multiple CLI measurement resources.

In a twelfth additional aspect, alone or in combination with one or more of the first through eleventh aspects, the configuration information indicates a mapping between information included in the communication and respective subsets of a resource set associated with the multiple CLI measurement resources.

In a thirteenth additional aspect, alone or in combination with one or more of the first through twelfth aspects, the multiple CLI measurement resources are included in a CLI measurement resource set, and where a quantity of CLI measurement resources that the first UE is capable of monitoring is associated with a quantity of CLI measurement resource sets, including the CLI measurement resource set, that are configured for the first UE.

In a fourteenth additional aspect, alone or in combination with one or more of the first through thirteenth aspects, a quantity of CLI measurement resources that are counted for the first UE is associated with CLI measurement resources, including the CLI measurement resource, that are activated by the network entity or another network entity.

In a fifteenth additional aspect, alone or in combination with one or more of the first through fourteenth aspects, the CLI measurement resources that are counted are associated with a single slot or multiple slots.

In a sixteenth additional aspect, alone or in combination with one or more of the first through fifteenth aspects, the CLI measurement resources that are counted are associated with a CLI measurement type.

In a seventeenth additional aspect, alone or in combination with one or more of the first through sixteenth aspects, the multiple CLI measurement resources are associated with a CLI measurement resource set, and where the CLI report is associated with the CLI measurement resource set.

In an eighteenth additional aspect, alone or in combination with one or more of the first through seventeenth aspects, the multiple CLI measurement resources are associated with a CLI measurement resource set, where the CLI measurement resource is associated with a subset of the CLI measurement resource set, and where the CLI report is associated with the subset.

Although FIG. 8 shows example blocks of the process 800, in some aspects, the process 800 may include additional blocks, fewer blocks, different blocks, or differently arranged blocks than those depicted in FIG. 8. Additionally, or alternatively, two or more of the blocks of the process 800 may be performed in parallel.

FIG. 9 is a diagram illustrating an example process 900 performed, for example, by a network entity. The process 900 is an example where the network entity (for example, the network entity 605, a network entity 110, a base station, a CU, a DU, or an RU) performs operations associated with a CLI measurement resource indication.

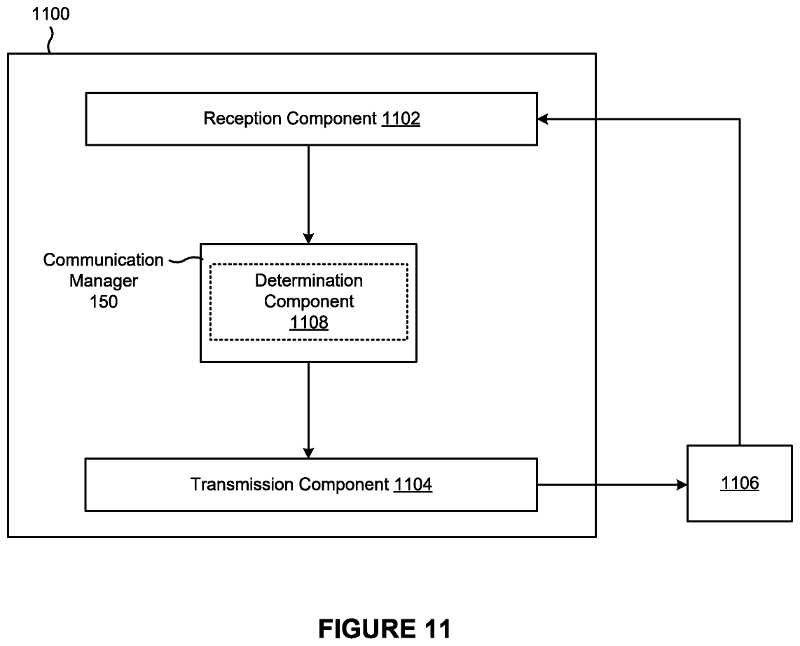

As shown in FIG. 9, in some aspects, the process 900 may include transmitting configuration information intended for a first UE indicating multiple CLI measurement resources that are associated with measuring CLI from a second UE (block 910). For example, the network entity (such as by using communication manager 150 or transmission component 1104, depicted in FIG. 11) may transmit configuration information intended for a first UE indicating CLI measurement resources that are associated with measuring CLI from a second UE.

As further shown in FIG. 9, in some aspects, the process 900 may include transmitting a communication indicating a CLI measurement resource, from the multiple CLI measurement resources, to be used to measure the CLI from the second UE (block 920). For example, the network entity (such as by using communication manager 150 or transmission component 1104, depicted in FIG. 11) may transmit a communication indicating a CLI measurement resource, from the multiple CLI measurement resources, to be used to measure the CLI from the second UE.

As further shown in FIG. 9, in some aspects, the process 900 may include receiving a CLI report indicating one or more measurements that are associated with the CLI measurement resource (block 930). For example, the network entity (such as by using communication manager 150 or reception component 1102, depicted in FIG. 11) may receive a CLI report indicating one or more measurements that are associated with the CLI measurement resource.

The process 900 may include additional aspects, such as any single aspect or any combination of aspects described in connection with the process 900 or in connection with one or more other processes described elsewhere herein.

In a first additional aspect, the process 900 includes transmitting another communication indicating another CLI measurement resource, from the multiple CLI measurement resources, to be used to measure the CLI from the second UE, and receiving another CLI report indicating one or more measurements that are associated with the other CLI measurement resource.

In a second additional aspect, alone or in combination with the first aspect, the communication is at least one of a MAC-CE communication, a downlink control channel communication, or a DCI communication.

In a third additional aspect, alone or in combination with one or more of the first and second aspects, the CLI measurement resource corresponds to an active uplink bandwidth part associated with the second UE.

In a fourth additional aspect, alone or in combination with one or more of the first through third aspects, the CLI measurement resource is a first CLI measurement resource, and where the multiple CLI measurement resources include the first CLI measurement resource corresponding to a first uplink bandwidth part associated with the second UE and a second CLI measurement resource corresponding to a second uplink bandwidth part associated with the second UE.

In a fifth additional aspect, alone or in combination with one or more of the first through fourth aspects, the configuration information indicates that each of the multiple CLI measurement resources is associated with a same resource set.

In a sixth additional aspect, alone or in combination with one or more of the first through fifth aspects, the configuration information indicates that a first one or more CLI measurement resources, from the multiple CLI measurement resources, are associated with a first subset of the same resource set, and that a second one or more CLI measurement resources, from the multiple CLI measurement resources, are associated with a second subset of the same resource set.

In a seventh additional aspect, alone or in combination with one or more of the first through sixth aspects, the first subset and the second subset are associated with a same uplink bandwidth part associated with the second UE.

In an eighth additional aspect, alone or in combination with one or more of the first through seventh aspects, the configuration information indicates at least one of a resource set or one or more subsets, associated with the resource set, for the multiple CLI measurement resources, corresponding to a CLI measurement type.

In a ninth additional aspect, alone or in combination with one or more of the first through eighth aspects, the configuration information indicates at least one of a resource set or one or more subsets, associated with the resource set, for the multiple CLI measurement resources, corresponding to all CLI measurement types.

In a tenth additional aspect, alone or in combination with one or more of the first through ninth aspects, the configuration information indicates a mapping between information included in the communication and respective CLI measurement resources of the multiple CLI measurement resources.

In an eleventh additional aspect, alone or in combination with one or more of the first through tenth aspects, the configuration information indicates a mapping between information included in the communication and respective subsets of a resource set associated with the multiple CLI measurement resources.

In a twelfth additional aspect, alone or in combination with one or more of the first through eleventh aspects, the multiple CLI measurement resources are included in a CLI measurement resource set, and where a quantity of CLI measurement resources that the first UE is capable of monitoring is associated with a quantity of CLI measurement resource sets, including the CLI measurement resource set, that are configured for the first UE.

In a thirteenth additional aspect, alone or in combination with one or more of the first through twelfth aspects, a quantity of CLI measurement resources that are counted for the first UE is associated with CLI measurement resources, including the CLI measurement resource, that are activated by the network entity or another network entity.

In a fourteenth additional aspect, alone or in combination with one or more of the first through thirteenth aspects, the CLI measurement resources that are counted are associated with a single slot or multiple slots.

In a fifteenth additional aspect, alone or in combination with one or more of the first through fourteenth aspects, the CLI measurement resources that are counted are associated with a CLI measurement type.

In a sixteenth additional aspect, alone or in combination with one or more of the first through fifteenth aspects, the multiple CLI measurement resources are associated with a CLI measurement resource set, and where the CLI report is associated with the CLI measurement resource set.

In a seventeenth additional aspect, alone or in combination with one or more of the first through sixteenth aspects, the multiple CLI measurement resources are associated with a CLI measurement resource set, where the CLI measurement resource is associated with a subset of the CLI measurement resource set, and where the CLI report is associated with the subset.

In an eighteenth additional aspect, alone or in combination with one or more of the first through seventeenth aspects, the CLI measurement resource corresponds to a first uplink bandwidth part associated with the second UE, and where transmitting the communication includes detecting that the second UE has switched from a second bandwidth part to the first bandwidth part, and transmitting the communication to cause the first UE to use the CLI measurement resource, that corresponds to the first uplink bandwidth part, to measure the CLI from the second UE.

Although FIG. 9 shows example blocks of the process 900, in some aspects, the process 900 may include additional blocks, fewer blocks, different blocks, or differently arranged blocks than those depicted in FIG. 9. Additionally, or alternatively, two or more of the blocks of the process 900 may be performed in parallel.

FIG. 10 is a diagram of an example apparatus 1000 for wireless communication. The apparatus 1000 may be a UE, or a UE may include the apparatus 1000. In some aspects, the apparatus 1000 includes a reception component 1002 and a transmission component 1004, which may be in communication with one another (for example, via one or more buses or one or more other components). As shown, the apparatus 1000 may communicate with another apparatus 1006 (such as a UE, a network entity, or another wireless communication device) using the reception component 1002 and the transmission component 1004. As further shown, the apparatus 1000 may include the communication manager 140. The communication manager 140 may include a measurement component 1008, among other examples.

In some aspects, the apparatus 1000 may be configured to perform one or more operations described herein in connection with FIGS. 6 and 7. Additionally, or alternatively, the apparatus 1000 may be configured to perform one or more processes described herein, such as process 800 of FIG. 8, or a combination thereof. In some aspects, the apparatus 1000 or one or more components shown in FIG. 10 may include one or more components of the UE described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1006. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, a modem, a demodulator, a MIMO detector, a receive processor, a controller/processor, a memory, or a combination thereof, of the UE described in connection with FIG. 2.

The transmission component 1004 may transmit communications, such as reference signals, control information, data communications, or a combination thereof, to the apparatus 1006. In some aspects, one or more other components of the apparatus 1000 may generate communications and may provide the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, a modem, a modulator, a transmit MIMO processor, a transmit processor, a controller/processor, a memory, or a combination thereof, of the UE described in connection with FIG. 2. In some aspects, the transmission component 1004 may be co-located with the reception component 1002 in a transceiver.

The reception component 1002 may receive, from a network entity, configuration information indicating multiple CLI measurement resources that are associated with measuring CLI from a second UE. The reception component 1002 may receive, from the network entity, a communication indicating a CLI measurement resource, from the multiple CLI measurement resources, to be used to measure the CLI from the second UE. The transmission component 1004 may transmit, to the network entity, a CLI report indicating one or more measurements that are associated with the CLI measurement resource.

The reception component 1002 may receive, from the network entity, another communication indicating another CLI measurement resource, from the multiple CLI measurement resources, to be used to measure the CLI from the second UE.

The transmission component 1004 may transmit, to the network entity, another CLI report indicating one or more measurements that are associated with the other CLI measurement resource.

The reception component 1002 may receive, from the second UE, one or more signals that are associated with the CLI measurement resource.

The measurement component 1008 may measure the one or more signals to obtain the one or more measurements.

The quantity and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

FIG. 11 is a diagram of an example apparatus 1100 for wireless communication. The apparatus 1100 may be a network entity, or a network entity may include the apparatus 1100. In some aspects, the apparatus 1100 includes a reception component 1102 and a transmission component 1104, which may be in communication with one another (for example, via one or more buses or one or more other components). As shown, the apparatus 1100 may communicate with another apparatus 1106 (such as a UE, another network entity, or another wireless communication device) using the reception component 1102 and the transmission component 1104. As further shown, the apparatus 1100 may include the communication manager 150. The communication manager 150 may include a determination component 1108, among other examples.

In some aspects, the apparatus 1100 may be configured to perform one or more operations described herein in connection with FIGS. 6 and 7. Additionally, or alternatively, the apparatus 1100 may be configured to perform one or more processes described herein, such as process 900 of FIG. 9, or a combination thereof. In some aspects, the apparatus 1100 or one or more components shown in FIG. 11 may include one or more components of the network entity described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1106. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, a modem, a demodulator, a MIMO detector, a receive processor, a controller/processor, a memory, or a combination thereof, of the network entity 110 described in connection with FIG. 2.

The transmission component 1104 may transmit communications, such as reference signals, control information, data communications, or a combination thereof, to the apparatus 1106. In some aspects, one or more other components of the apparatus 1100 may generate communications and may provide the generated communications to the transmission component 1104 for transmission to the apparatus 1106. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1106. In some aspects, the transmission component 1104 may include one or more antennas, a modem, a modulator, a transmit MIMO processor, a transmit processor, a controller/processor, a memory, or a combination thereof, of the network entity 110 described in connection with FIG. 2. In some aspects, the transmission component 1104 may be co-located with the reception component 1102 in a transceiver.

The transmission component 1104 may transmit configuration information intended for a first UE indicating multiple CLI measurement resources that are associated with measuring CLI from a second UE. The transmission component 1104 may transmit a communication indicating a CLI measurement resource, from the multiple CLI measurement resources, to be used to measure the CLI from the second UE. The reception component 1102 may receive a CLI report indicating one or more measurements that are associated with the CLI measurement resource.

The transmission component 1104 may transmit another communication indicating another CLI measurement resource, from the multiple CLI measurement resources, to be used to measure the CLI from the second UE.

The reception component 1102 may receive another CLI report indicating one or more measurements that are associated with the other CLI measurement resource.

The determination component 1108 may determine the configuration information. The determination component 1108 may determine the configuration based on or associated with a capability associated with the first UE.

The quantity and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

The following provides an overview of some Aspects of the present disclosure:

Aspect 1: A method of wireless communication performed by an apparatus of a first user equipment (UE), including: receiving, from a network entity, configuration information indicating multiple cross link interference (CLI) measurement resources that are associated with measuring CLI from a second UE; receiving, from the network entity, a communication indicating a CLI measurement resource, from the multiple CLI measurement resources, to be used to measure the CLI from the second UE; and transmitting, to the network entity, a CLI report indicating one or more measurements that are associated with the CLI measurement resource.

Aspect 2: The method of Aspect 1, further includes: receiving, from the network entity, another communication indicating another CLI measurement resource, from the multiple CLI measurement resources, to be used to measure the CLI from the second UE; and transmitting, to the network entity, another CLI report indicating one or more measurements that are associated with the other CLI measurement resource.

Aspect 3: The method of any of Aspects 1-2, further including: receiving, from the second UE, one or more signals that are associated with the CLI measurement resource; and measuring the one or more signals to obtain the one or more measurements.

Aspect 4: The method of any of Aspects 1-3, where the communication is at least one of: a medium access control (MAC) control element (MAC-CE) communication, a downlink control channel communication, or a downlink control information (DCI) communication.

Aspect 5: The method of any of Aspects 1-4, where the CLI measurement resource corresponds to an active uplink bandwidth part associated with the second UE.

Aspect 6: The method of any of Aspects 1-5, where the CLI measurement resource is a first CLI measurement resource, and where the multiple CLI measurement resources include the first CLI measurement resource corresponding to a first uplink bandwidth part associated with the second UE and a second CLI measurement resource corresponding to a second uplink bandwidth part associated with the second UE.

Aspect 7: The method of any of Aspects 1-6, where the configuration information indicates that each of the multiple CLI measurement resources is associated with a same resource set.

Aspect 8: The method of Aspect 7, where the configuration information indicates that a first one or more CLI measurement resources, from the multiple CLI measurement resources, are associated with a first subset of the same resource set, and that a second one or more CLI measurement resources, from the multiple CLI measurement resources, are associated with a second subset of the same resource set.

Aspect 9: The method of Aspect 8, where the first subset and the second subset are associated with a same uplink bandwidth part associated with the second UE.

Aspect 10: The method of any of Aspects 1-9, where the configuration information indicates at least one of a resource set or one or more subsets, associated with the resource set, for the multiple CLI measurement resources, corresponding to a CLI measurement type.

Aspect 11: The method of any of Aspects 1-10, where the configuration information indicates at least one of a resource set or one or more subsets, associated with the resource set, for the multiple CLI measurement resources, corresponding to all CLI measurement types.

Aspect 12: The method of any of Aspects 1-11, where the configuration information indicates a mapping between information included in the communication and respective CLI measurement resources of the multiple CLI measurement resources.

Aspect 13: The method of any of Aspects 1-12, where the configuration information indicates a mapping between information included in the communication and respective subsets of a resource set associated with the multiple CLI measurement resources.

Aspect 14: The method of any of Aspects 1-13, where the multiple CLI measurement resources are included in a CLI measurement resource set, and where a quantity of CLI measurement resources that the first UE is capable of monitoring is associated with a quantity of CLI measurement resource sets, including the CLI measurement resource set, that are configured for the first UE.

Aspect 15: The method of any of Aspects 1-14, where a quantity of CLI measurement resources that are counted for the first UE is associated with CLI measurement resources, including the CLI measurement resource, that are activated by the network entity or another network entity.

Aspect 16: The method of Aspect 15, where the CLI measurement resources that are counted are associated with a single slot or multiple slots.

Aspect 17: The method of any of Aspects 15-16, where the CLI measurement resources that are counted are associated with a CLI measurement type.

Aspect 18: The method of any of Aspects 1-17, where the multiple CLI measurement resources are associated with a CLI measurement resource set, and where the CLI report is associated with the CLI measurement resource set.

Aspect 19: The method of any of Aspects 1-18, where the multiple CLI measurement resources are associated with a CLI measurement resource set, where the CLI measurement resource is associated with a subset of the CLI measurement resource set, and where the CLI report is associated with the subset.

Aspect 20: A method of wireless communication performed by an apparatus of a network entity, including: transmitting configuration information intended for a first user equipment (UE) indicating multiple cross link interference (CLI) measurement resources that are associated with measuring CLI from a second UE; transmitting a communication indicating a CLI measurement resource, from the multiple CLI measurement resources, to be used to measure the CLI from the second UE; and receiving a CLI report indicating one or more measurements that are associated with the CLI measurement resource.

Aspect 21: The method of Aspect 20, further including: transmitting another communication indicating another CLI measurement resource, from the multiple CLI measurement resources, to be used to measure the CLI from the second UE; and receiving another CLI report indicating one or more measurements that are associated with the other CLI measurement resource.

Aspect 22: The method of any of Aspects 20-21, where the communication is at least one of: a medium access control (MAC) control element (MAC-CE) communication, a downlink control channel communication, or a downlink control information (DCI) communication.

Aspect 23: The method of any of Aspects 20-22, where the CLI measurement resource corresponds to an active uplink bandwidth part associated with the second UE.

Aspect 24: The method of any of Aspects 20-23, where the CLI measurement resource is a first CLI measurement resource, and where the multiple CLI measurement resources include the first CLI measurement resource corresponding to a first uplink bandwidth part associated with the second UE and a second CLI measurement resource corresponding to a second uplink bandwidth part associated with the second UE.

Aspect 25: The method of any of Aspects 20-24, where the configuration information indicates that each of the multiple CLI measurement resources is associated with a same resource set.

Aspect 26: The method of Aspect 25, where the configuration information indicates that a first one or more CLI measurement resources, from the multiple CLI measurement resources, are associated with a first subset of the same resource set, and that a second one or more CLI measurement resources, from the multiple CLI measurement resources, are associated with a second subset of the same resource set.

Aspect 27: The method of Aspect 26, where the first subset and the second subset are associated with a same uplink bandwidth part associated with the second UE.

Aspect 28: The method of any of Aspects 20-27, where the configuration information indicates at least one of a resource set or one or more subsets, associated with the resource set, for the multiple CLI measurement resources, corresponding to a CLI measurement type.

Aspect 29: The method of any of Aspects 20-28, where the configuration information indicates at least one of a resource set or one or more subsets, associated with the resource set, for the multiple CLI measurement resources, corresponding to all CLI measurement types.

Aspect 30: The method of any of Aspects 20-29, where the configuration information indicates a mapping between information included in the communication and respective CLI measurement resources of the multiple CLI measurement resources.

Aspect 31: The method of any of Aspects 20-30, where the configuration information indicates a mapping between information included in the communication and respective subsets of a resource set associated with the multiple CLI measurement resources.

Aspect 32: The method of any of Aspects 20-31, where the multiple CLI measurement resources are included in a CLI measurement resource set, and where a quantity of CLI measurement resources that the first UE is capable of monitoring is associated with a quantity of CLI measurement resource sets, including the CLI measurement resource set, that are configured for the first UE.

Aspect 33: The method of any of Aspects 20-32, where a quantity of CLI measurement resources that are counted for the first UE is associated with CLI measurement resources, including the CLI measurement resource, that are activated by the network entity or another network entity.

Aspect 34: The method of Aspect 33, where the CLI measurement resources that are counted are associated with a single slot or multiple slots.

Aspect 35: The method of any of Aspects 33-34, where the CLI measurement resources that are counted are associated with a CLI measurement type.

Aspect 36: The method of any of Aspects 20-35, where the multiple CLI measurement resources are associated with a CLI measurement resource set, and where the CLI report is associated with the CLI measurement resource set.

Aspect 37: The method of any of Aspects 20-36, where the multiple CLI measurement resources are associated with a CLI measurement resource set, where the CLI measurement resource is associated with a subset of the CLI measurement resource set, and where the CLI report is associated with the subset.

Aspect 38: The method of any of Aspects 20-37, where the CLI measurement resource corresponds to a first uplink bandwidth part associated with the second UE, and where transmitting the communication includes: detecting that the second UE has switched from a second bandwidth part to the first bandwidth part; and transmitting the communication to cause the first UE to use the CLI measurement resource, that corresponds to the first uplink bandwidth part, to measure the CLI from the second UE.

Aspect 39: An apparatus for wireless communication at a device, including a processor; memory coupled with the processor; and instructions stored in the memory and executable by the processor to cause the apparatus to perform the method of one or more of Aspects 1-19.

Aspect 40: A device for wireless communication, including a memory and one or more processors coupled to the memory, the one or more processors configured to perform the method of one or more of Aspects 1-19.

Aspect 41: An apparatus for wireless communication, including at least one means for performing the method of one or more of Aspects 1-19.

Aspect 42: A non-transitory computer-readable medium storing code for wireless communication, the code including instructions executable by a processor to perform the method of one or more of Aspects 1-19.

Aspect 43: A non-transitory computer-readable medium storing a set of instructions for wireless communication, the set of instructions including one or more instructions that, when executed by one or more processors of a device, cause the device to perform the method of one or more of Aspects 1-19.

Aspect 44: An apparatus for wireless communication at a device, including a processor; memory coupled with the processor; and instructions stored in the memory and executable by the processor to cause the apparatus to perform the method of one or more of Aspects 20-38.

Aspect 45: A device for wireless communication, including a memory and one or more processors coupled to the memory, the one or more processors configured to perform the method of one or more of Aspects 20-38.

Aspect 46: An apparatus for wireless communication, including at least one means for performing the method of one or more of Aspects 20-38.

Aspect 47: A non-transitory computer-readable medium storing code for wireless communication, the code including instructions executable by a processor to perform the method of one or more of Aspects 20-38.

Aspect 48: A non-transitory computer-readable medium storing a set of instructions for wireless communication, the set of instructions including one or more instructions that, when executed by one or more processors of a device, cause the device to perform the method of one or more of Aspects 20-38.

The foregoing disclosure provides illustration and description but is not intended to be exhaustive or to limit the aspects to the precise forms disclosed. Modifications and variations may be made in light of the disclosure or may be acquired from practice of the aspects.

As used herein, the term “component” is intended to be broadly construed as hardware, firmware, or a combination of hardware and software. As used herein, a processor is implemented in hardware, firmware, or a combination of hardware and software. As used herein, the phrase “based on” is intended to be broadly construed to mean “based at least in part on.” As used herein, “satisfying a threshold” may, depending on the context, refer to a value being greater than the threshold, greater than or equal to the threshold, less than the threshold, less than or equal to the threshold, equal to the threshold, or not equal to the threshold, among other examples. As used herein, a phrase referring to “at least one of” a list of items refers to any combination of those items, including single members. As an example, “at least one of: a, b, or c” is intended to cover: a, b, c, a+b, a+c, b+c, and a+b+c.

Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (for example, related items, unrelated items, or a combination of related and unrelated items), and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A also may have B). Further, as used herein, the term “or” is intended to be inclusive when used in a series and may be used interchangeably with “and/or,” unless explicitly stated otherwise (for example, if used in combination with “either” or “only one of”).

The various illustrative logics, logical blocks, modules, circuits and algorithm processes described in connection with the aspects disclosed herein may be implemented as electronic hardware, computer software, or combinations of both. The interchangeability of hardware and software has been described generally, in terms of functionality, and illustrated in the various illustrative components, blocks, modules, circuits and processes described herein. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, for example, a combination of a DSP and a microprocessor, a plurality of microprocessors, one or more microprocessors in conjunction with a DSP core, or any other such configuration. In some aspects, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Aspects of the subject matter described in this specification also can be implemented as one or more computer programs (such as one or more modules of computer program instructions) encoded on a computer storage media for execution by, or to control the operation of, a data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the media described herein should also be included within the scope of computer-readable media. Additionally, the operations of a method or algorithm may reside as one or any combination or set of codes and instructions on a machine readable medium and computer-readable medium, which may be incorporated into a computer program product.

Various modifications to the aspects described in this disclosure may be readily apparent to those skilled in the art, and the generic principles defined herein may be applied to other aspects without departing from the spirit or scope of this disclosure. Thus, the claims are not intended to be limited to the aspects shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate aspects also can be implemented in combination in a single aspect. Conversely, various features that are described in the context of a single aspect also can be implemented in multiple aspects separately or in any suitable subcombination. Moreover, although features may be described as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the aspects described should not be understood as requiring such separation in all aspects, and it should be understood that the described program components and systems can generally be integrated together in a single software product or packaged into multiple software products. Additionally, other aspects are within the scope of the following claims. In some cases, the actions recited in the claims can be performed in a different order and still achieve desirable results.

What is claimed is:

1. A method of wireless communication performed by an apparatus of a first user equipment (UE), comprising:
receiving, from a network entity, configuration information indicating multiple cross link interference (CLI) measurement resources that are associated with measuring CLI from a second UE;
receiving, from the network entity, a communication indicating a CLI measurement resource, from the multiple CLI measurement resources, to be used to measure the CLI from the second UE; and
transmitting, to the network entity, a CLI report indicating one or more measurements that are associated with the CLI measurement resource.

2. The method of claim 1, further comprising:
receiving, from the network entity, another communication indicating another CLI measurement resource, from the multiple CLI measurement resources, to be used to measure the CLI from the second UE; and
transmitting, to the network entity, another CLI report indicating one or more measurements that are associated with the other CLI measurement resource.

3. The method of claim 1, further comprising:
receiving, from the second UE, one or more signals that are associated with the CLI measurement resource; and
measuring the one or more signals to obtain the one or more measurements.

4. The method of claim 1, wherein the communication is at least one of:
a medium access control (MAC) control element (MAC-CE) communication,
a downlink control channel communication, or
a downlink control information (DCI) communication.

5. The method of claim 1, wherein the CLI measurement resource corresponds to an active uplink bandwidth part associated with the second UE.

6. The method of claim 1, wherein the configuration information indicates that each of the multiple CLI measurement resources is associated with a same resource set.

7. The method of claim 6, wherein the configuration information indicates that a first one or more CLI measurement resources, from the multiple CLI measurement resources, are associated with a first subset of the same resource set, and that a second one or more CLI measurement resources, from the multiple CLI measurement resources, are associated with a second subset of the same resource set.

8. The method of claim 1, wherein the configuration information indicates at least one of a resource set or one or more subsets, associated with the resource set, for the multiple CLI measurement resources, corresponding to a CLI measurement type.

9. The method of claim 1, wherein the configuration information indicates at least one of a resource set or one or more subsets, associated with the resource set, for the multiple CLI measurement resources, corresponding to all CLI measurement types.

10. The method of claim 1, wherein the configuration information indicates a mapping between information included in the communication and respective CLI measurement resources of the multiple CLI measurement resources.

11. The method of claim 1, wherein the multiple CLI measurement resources are included in a CLI measurement resource set, and wherein a quantity of CLI measurement resources that the first UE is capable of monitoring is associated with a quantity of CLI measurement resource sets, including the CLI measurement resource set, that are configured for the first UE.

12. The method of claim 1, wherein a quantity of CLI measurement resources that are counted for the first UE is associated with CLI measurement resources, including the CLI measurement resource, that are activated by the network entity or another network entity.

13. The method of claim 1, wherein the multiple CLI measurement resources are associated with a CLI measurement resource set, and wherein the CLI report is associated with the CLI measurement resource set.

14. A method of wireless communication performed by an apparatus of a network entity, comprising:
transmitting configuration information intended for a first user equipment (UE) indicating multiple cross link interference (CLI) measurement resources that are associated with measuring CLI from a second UE;
transmitting a communication indicating a CLI measurement resource, from the multiple CLI measurement resources, to be used to measure the CLI from the second UE; and
receiving a CLI report indicating one or more measurements that are associated with the CLI measurement resource.

15. The method of claim 14, further comprising:
transmitting another communication indicating another CLI measurement resource, from the multiple CLI measurement resources, to be used to measure the CLI from the second UE; and
receiving another CLI report indicating one or more measurements that are associated with the other CLI measurement resource.

16. The method of claim 14, wherein the CLI measurement resource is a first CLI measurement resource, and
wherein the multiple CLI measurement resources include the first CLI measurement resource corresponding to a first uplink bandwidth part associated with the second UE and a second CLI measurement resource corresponding to a second uplink bandwidth part associated with the second UE.

17. The method of claim 14, wherein the multiple CLI measurement resources are included in a CLI measurement resource set, and wherein a quantity of CLI measurement resources that the first UE is capable of monitoring is associated with a quantity of CLI measurement resource sets, including the CLI measurement resource set, that are configured for the first UE.

18. The method of claim 14, wherein a quantity of CLI measurement resources that are counted for the first UE is associated with CLI measurement resources, including the CLI measurement resource, that are activated by the network entity or another network entity.

19. The method of claim 14, wherein the CLI measurement resource corresponds to a first uplink bandwidth part associated with the second UE, and wherein transmitting the communication comprises:
detecting that the second UE has switched from a second bandwidth part to the first bandwidth part; and
transmitting the communication to cause the first UE to use the CLI measurement resource, that corresponds to the first uplink bandwidth part, to measure the CLI from the second UE.

20. An apparatus of a first user equipment (UE) for wireless communication, comprising:
a first interface configured to obtain, from a network entity, configuration information indicating multiple cross link interference (CLI) measurement resources that are associated with measuring CLI from a second UE;
the first interface configured to obtain, from the network entity, a communication indicating a CLI measurement resource, from the multiple CLI measurement resources, to be used to measure the CLI from the second UE; and
the first interface or a second interface configured to output, to the network entity, a CLI report indicating one or more measurements that are associated with the CLI measurement resource.

21. The apparatus of claim 20, wherein the first interface is further configured to:
obtain, from the network entity, another communication indicating another CLI measurement resource, from the multiple CLI measurement resources, to be used to measure the CLI from the second UE; and
wherein first interface or a second interface is further configured to output, to the network entity, another CLI report indicating one or more measurements that are associated with the other CLI measurement resource.

22. The apparatus of claim 20, wherein the first interface is further configured:
obtain, from the second UE, one or more signals that are associated with the CLI measurement resource; and
the apparatus further comprising a processing system configured to measure the one or more signals to obtain the one or more measurements.

23. The apparatus of claim 20, wherein the configuration information indicates that each of the multiple CLI measurement resources is associated with a same resource set,
wherein the configuration information indicates that a first one or more CLI measurement resources, from the multiple CLI measurement resources, are associated with a first subset of the same resource set, and that a second one or more CLI measurement resources, from the multiple CLI measurement resources, are associated with a second subset of the same resource set, and
wherein the first subset and the second subset are associated with a same uplink bandwidth part associated with the second UE.

24. The apparatus of claim 20, wherein the multiple CLI measurement resources are included in a CLI measurement resource set, and wherein a quantity of CLI measurement resources that the first UE is capable of monitoring is associated with a quantity of CLI measurement resource sets, including the CLI measurement resource set, that are configured for the first UE.

25. The apparatus of claim 20, wherein a quantity of CLI measurement resources that are counted for the first UE is associated with CLI measurement resources, including the CLI measurement resource, that are activated by the network entity or another network entity, and
wherein the CLI measurement resources that are counted are associated with at least one of:
a single slot or multiple slots, or
a CLI measurement type.

26. An apparatus of a network entity for wireless communication, comprising:
a first interface configured to output configuration information intended for a first user equipment (UE) indicating multiple cross link interference (CLI) measurement resources that are associated with measuring CLI from a second UE;
the first interface configured to output a communication indicating a CLI measurement resource, from the multiple CLI measurement resources, to be used to measure the CLI from the second UE; and
the first interface or a second interface configured to obtain a CLI report indicating one or more measurements that are associated with the CLI measurement resource.

27. The apparatus of claim 26, wherein the first interface is further configured to:
obtain another communication indicating another CLI measurement resource, from the multiple CLI measurement resources, to be used to measure the CLI from the second UE; and
obtain another CLI report indicating one or more measurements that are associated with the other CLI measurement resource.

28. The apparatus of claim 26, wherein the CLI measurement resource corresponds to an active uplink bandwidth part associated with the second UE.

29. The apparatus of claim 26, wherein the configuration information indicates a mapping between information included in the communication and respective CLI measurement resources of the multiple CLI measurement resources.

30. The apparatus of claim 26, wherein the CLI measurement resource corresponds to a first uplink bandwidth part associated with the second UE, and wherein the apparatus further comprises:
a processing system configured to detect that the second UE has switched from a second bandwidth part to the first bandwidth part; and
wherein the first interface, to output the communication, is configured to output the communication to cause the first UE to use the CLI measurement resource, that corresponds to the first uplink bandwidth part, to measure the CLI from the second UE.
